(19) United States
(12) Patent Application Publication
(10) Pub. No.: US 2006/0146660 A1
(43) Pub. Date: Jul. 6, 2006

(54) Optical disc, reproducing device, program, reproducing method, recording method

(76) Inventors: Wataru Ikeda, Osaka-shi (JP); Tomoyuki Okada, Nara-shi (JP); Yasushi Uesaka, Sanda-shi (JP); Masayuki Kozuka, Neyagawa-shi (JP)

Correspondence Address: SNELL & WILMER L.L.P., 600 ANTON BOULEVARD, SUITE 1400, COSTA MESA, CA, 92626, US

(21) Appl. No.: 10/529,517

(22) PCT Filed: Oct. 10, 2003
(86) PCT No.: PCT/JP03/13026

§ 371 Date: Oct. 11, 2005

(30) Foreign Application Priority Data
Oct. 10, 2002 (US) 60/417306

(51) Int. Cl. G11B 7/085

(52) U.S. Cl. 369/30.13

(57) ABSTRACT

An optical disc has recorded therein an AV stream divided into segments. An interleave unit is recorded in front of an ith segment to be played back in an ith place among the segments. The interleave unit includes a library whose live range has a start point that falls during a playback time of the ith segment.

### FIELD OF INVENTION

The present invention relates to an optical disc for a digital stream, such as a blu-ray disc read only memory (hereinafter abbreviated as “BD-ROM”). The present invention also relates to a playback apparatus, a program, a playback method, and a recording method of such an optical disc. The present invention further relates to a technology for distributing movie works and the like via such an optical disc.

### BACKGROUND ART

Relating to distribution of movie works via optical discs, there is a type of business by which a movie work relating to a character is distributed in a same optical disc in which a game relating to the character is also recorded. Games to be recorded in optical discs are developing from simple ones as in quiz format, to full-fledged ones in which three-dimensional computer graphics is incorporated. The following patent reference 1 discloses an example of prior art that records a game program which is non-AV data, in the same optical disc prestoring AV data constituting the substance of a movie work.

<Patent reference 1> Japanese Patent Publication No. 3069324

However in conventional full-fledged games, in which computer graphics is incorporated, a variety of libraries is required to be pre-loaded to the memory, for use by an application program for operation, the libraries including those for rendering computer graphics. A hardware specification for consumer products, such as a DVD player, cannot satisfy such an operation environment, and so users have to play such games on other operation environments such as a personal computer. This means that it often becomes necessary to remind users by “recommended operation environment: memory size of at least 128 megabytes”, or the like.

Even when an optical disc includes a full-fledged game, if the operation environment required for the game is far different from that for the movie work itself, it is natural for users not to feel inclined to purchase the optical disc. This makes it meaningless to produce games at such high development cost, so as to be incorporated in a disc in which the movie work is also recorded.

### DISCLOSURE OF INVENTION

The object of the present invention, in view of the stated problems, is to provide, in distributing a program to realize a game in the form recorded in an optical disc, an optical disc whose operation environment is close to an operation environment of the substance of the movie work as much as possible.

The above-stated object is achieved by

[symbol]

With the above construction, a program to be synchronized with playback of a segment is disposed in front of the segment in the form of an interleave unit. According to this structure, it becomes possible to read each segment constituting the digital stream, together with a program to be synchronized with the segment, by only a move of the read position of the optical pickup a little away from the beginning position of the segment. Accordingly, it is sufficient to read a program necessary in synchronization from an optical disc, in reading of a corresponding segment. After the synchronization with the segment, the program can be deleted from a memory. Therefore it is not necessary to have the program reside in the memory throughout the entire sections of the digital stream playback. If there are a plurality of programs to be synchronized with the digital stream, a resource management becomes possible by which each program is collected from the memory every time the program execution has been complete. With such a resource management, the amount of a memory to be mounted to the playback apparatus is only a size sufficient to be able to perform program loading. As a result, it becomes possible to perform a digital stream playback as well as synchronized processing of a variety of programs together therewith.

Here,

[symbol]

With the above construction, ending time information is set for an interleave unit. Accordingly, it is possible to determine, in the authoring stage of an optical disc, a resource management that prescribes at what time the interleave unit is read to a memory, and until what time the interleave unit has to be deleted from the memory. If programming is performed according to such resource management, it is possible to realize game software that requires synchronization with AV playback of a digital stream, with a minimum amount of memory. For programmers of software companies, realization of an operating environment in which synchronization with AV playback is attractive. Accordingly, the invention can invigorate the movie market and the consumer goods market, by encouraging more software companies to move into the markets.

[symbol]

With the above construction, even when three libraries are disposed in separate positions on the optical disc, the three libraries are able to be used at a same time, by adjusting the start-time information of the header of each library.

[symbol]

[symbol]

With the above construction, it is possible to dispose a copy of interleave unit after the position at which a frequent random access is expected (e.g. a start point of a playback section) If doing so, the application program can use a library without a disc seek up to an interleave unit disposed ahead of a segment. Even when a random access is more frequent due to playback based on playback path information, smooth reading is realized.

[symbol]

With the above construction, even when playback is performed in the direction from the future to the past on the playback time axis of the digital stream, program reading from the optical disc to the memory is enabled without any unnecessary seek. Even in irregular playback progressions such as the above-stated reverse playback, program reading to the memory becomes possible, and so a variety of processing that assumes synchronization with AV playback is realized even in the reverse playback, for example.

[symbol]

Since each live range is defined with use of identifiers of a dynamic scenario, the playlist information, and so on, it becomes easy to grasp interleave units whose live ranges overlap with each other, and so it becomes easy to make a plan of reading interleave units with the resource management in mind.

### BRIEF DESCRIPTION OF THE DRAWINGS

FIG. 1 is a diagram showing an entire structure of a multidisplay apparatus relating to the first embodiment of the present invention.

FIG. 2 is a diagram showing a structure of a BD-ROM.

FIG. 3 is a diagram representing an application-layer format of a BD-ROM, in a directory structure.

FIG. 4 is a classification diagram showing the classification of files in a functional point of view.

FIG. 5 is a diagram showing a layer model of a software program that a BD-ROM targets.

FIG. 6 is a diagram schematically showing a structure of an AV stream.

FIG. 7 is a diagram schematically showing how the AV stream is recorded into the BD-ROM.

FIG. 8 is a diagram showing an internal structure of stream management information.

FIG. 9 is a diagram showing an internal structure of PL information.

FIG. 10 is a diagram schematically showing an indirect reference by means of PL information.

FIG. 11 is a diagram showing one example of a different PL from the PL information that is shown in FIG. 10.

FIG. 12 is a diagram showing a playback mode in the fourth layer (dynamic scenario) of the layer model.

FIG. 13 is a diagram showing a control software layer model of the Java platform that the Java language targets.

FIG. 14 is a diagram showing an AV stream that is to be a target of live range setting.

FIG. 15A is a diagram showing how segments are recorded into a BD-ROM.

FIG. 15B shows a read path by way of an optical pickup, when the segment i and the segment i+1 are successively read.

FIG. 16 is a diagram showing a moving path of an optical pickup when a random access is performed to the segment i+1.

FIG. 17 is a diagram showing how 1) reading of a library to the memory, and 2) loading of the library to the work area of the Java virtual machine, are performed at each time points (t1, t2, t3, and t4) on the playback time axis of the AV stream.

FIG. 18 is a diagram showing a structure of an interleave unit.

FIG. 19 is a diagram showing improvement for ACCESS UNIT entry in a TMAP.

FIG. 20 is a diagram showing a state transition of a track buffer when a segment constituting the AV stream is read out.

FIG. 21 is a diagram showing a game program constituted by an overlaid image made of: a moving image from a movie work as the background; and computer graphics as the foreground.

FIG. 22A is a diagram showing live ranges for libraries #1, #2, #3, and #4, respectively.

FIG. 22B is a diagram showing a relation between IN-points of live ranges of libraries and segments.

FIG. 23 is a diagram showing in what manner each segment is recorded in the BD-ROM.

FIG. 24 is a diagram showing an internal structure of an interleave unit.

FIG. 25 is a diagram showing an internal structure of a playback apparatus according to the present invention.

FIG. 26 is a flowchart showing an executing procedure of a playback control engine 12.

FIG. 27 is a diagram in which, from among the constituting elements of FIG. 25, library-related elements are extracted and drawn.

FIG. 28 is a diagram showing where display data is positioned in the layer model that the Java language targets.

FIG. 29 is a diagram showing a structure of an interleave unit storing therein display data.

FIG. 30 shows a path via which display data in the playback apparatus is displayed.

FIG. 31 is a diagram showing where in a segment a copy of an interleave unit should be incorporated.

FIG. 32 is a diagram showing how program reading is performed when random access is performed to a midway position of a segment i.

FIG. 33 is a diagram showing a relation between four libraries #1, #2, #3, and #4 (of FIGS. 22A and 22B) and segments.

FIG. 34A is a diagram showing placement of interleave unit, segment, and copy of interleave unit.

FIG. 34B is to which the i+1th segment is added to FIG. 34A.

FIG. 35 is a diagram showing how reverse playback is performed when there is no copy of interleave unit.

FIG. 36 is a diagram showing seek operations for a BD-ROM in which a copy of interleave unit is incorporated.

FIG. 37 is a diagram showing a relation between four libraries #1, #2, #3, and #4 shown in FIG. 22 and segments.

FIG. 38 is a flowchart showing a processing procedure performed by the playback control engine 12, when a user has instructed a reverse playback operation.

FIG. 39 is a diagram showing a structure of a file structure of a BD-ROM according to the fifth embodiment.

FIG. 40 is a diagram showing a common structure shared by PLMark and ClipMark.

FIGS. 41A and 41B are diagrams showing description examples of PLMark, in defining TimeEvent appearing during playback of a playlist #1.

FIG. 42 is a diagram showing a description example of PLMark in defining UserEvent during playback of the playlist #1.

FIG. 43 is a diagram showing a placement example of interleave unit, when ClipMark and PL define TimeEvent and UserEvent.

FIG. 44 is a diagram showing a processing procedure performed by the playback control engine 12.

FIG. 45 is a diagram showing how indirect reference is performed to information relating to interleave unit.

FIG. 46 is a diagram showing the relation between interleave-unit general information and three interleave units incorporated in the AV stream.

FIG. 47 is a diagram showing how live ranges are represented in the interleave units according to the seventh embodiment.

FIG. 48 is a diagram schematically showing a hierarchical organization of either a program or display data by locator description.

FIG. 49 is a diagram showing an internal structure of a playback apparatus according to the ninth embodiment.

FIG. 50 is a flowchart showing the manufacturing method of the BD-ROM of the eleventh embodiment.

FIG. 51 is a diagram showing an interleave unit storing a plurality of pieces of display data.

### BEST MODE FOR CARRYING OUT THE INVENTION

### First Embodiment

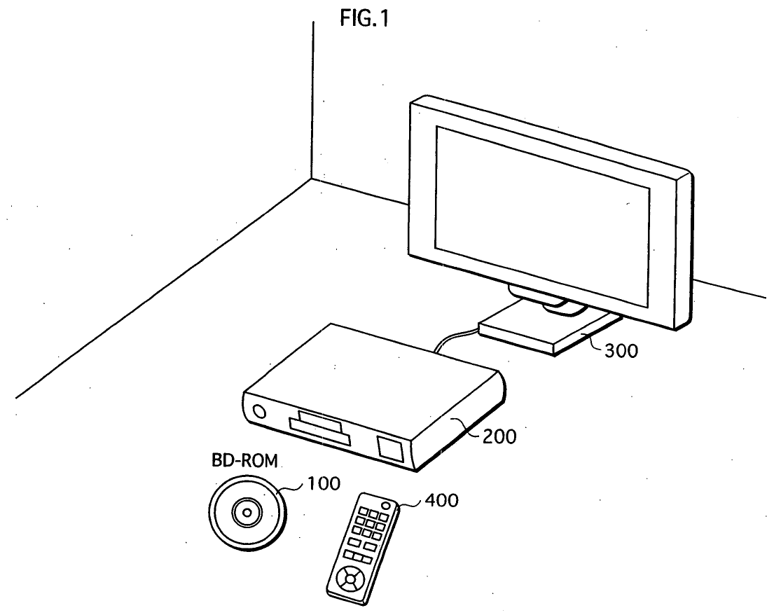

The following describes an embodiment of an optical disc relating to the present invention. First of all, among the embodiments of the optical disc relating to the present invention, an embodiment relating to use of the optical disc is described. FIG. 1 is a diagram showing how the optical disc of the present invention is used. In FIG. 1, the optical disc relating to the present invention is a BD-ROM 100. This BD-ROM 100 is used to supply a movie work to a home theater system comprised of a playback apparatus 200, a television 300, and a remote controller 400.

Next, the production of the optical disc, among the embodiments of the optical disc, is described. The optical disc relating to the present invention is executable by improvement directed to the application layer of the BD-ROM.

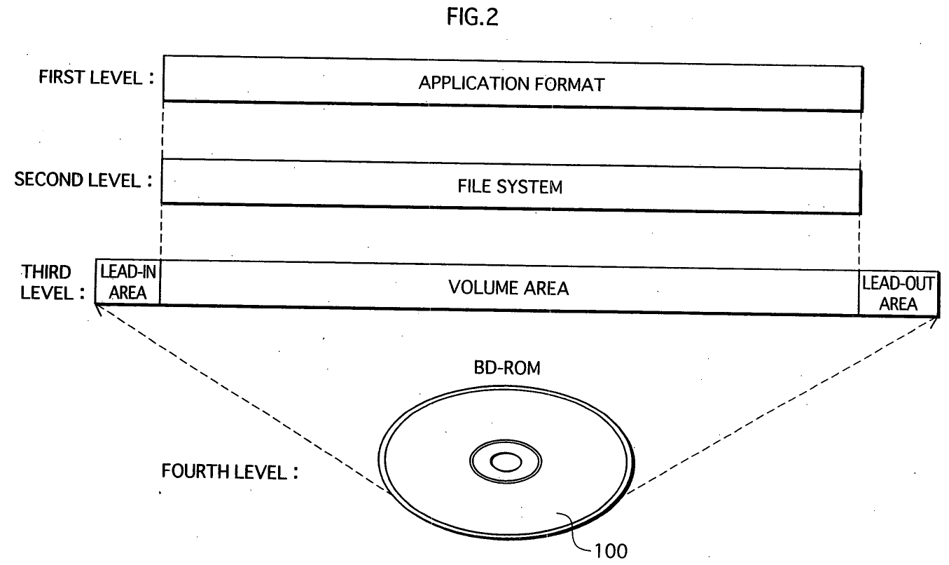

FIG. 2 is a diagram showing a structure of the BD-ROM. The BD-ROM is shown in the fourth level of this diagram, and a track on this BD-ROM is shown in the third level. In this drawing, a spiral track, formed from the inner side of the BD-ROM towards the outer side thereof, is extended in the horizontal direction. This track is comprised of a lead-in area, a volume area, and a lead-out area. The volume area in this drawing has layer models: a physical layer, a file system layer, and an application layer. The optical disc of the present invention is industrially manufactured, by forming the data format as shown in FIG. 2 on the application layer of the BD-ROM.

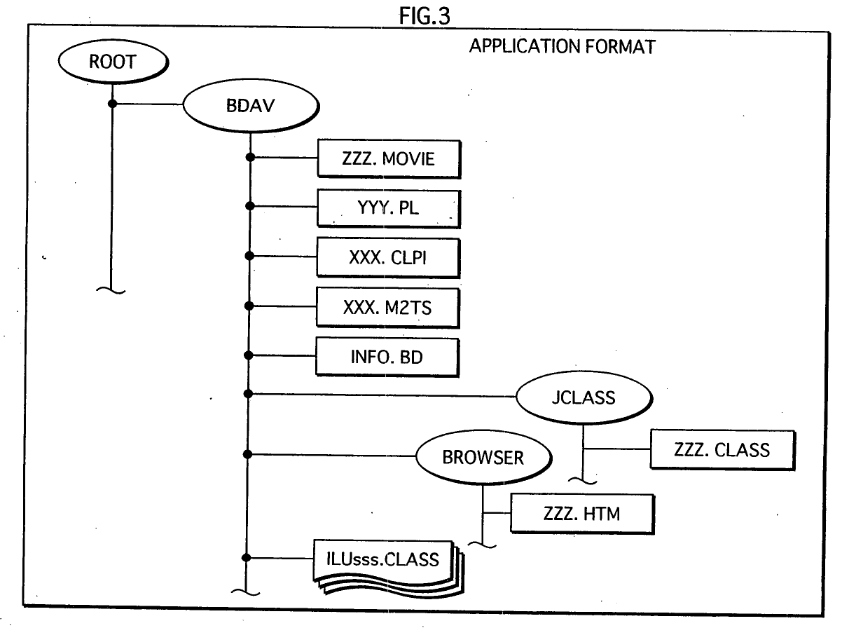

FIG. 3 is a diagram representing an application-layer format (application) of the BD-ROM, in a directory structure. As shown in this drawing, the BD-ROM has a BD-AV directory under a ROOT directory, and under the BD-AV directory, there are a JCLASS directory, and a BROWSER directory. Under the BDAV directory, files such as INFO.BD, XXX.M2TS, XXX.CLPI, YYY.PL, and ZZZ.MOVIE exist. Under the JCLASS directory, a file called ZZZ.CLASS exists, and under the BROWSER directory, a file called ZZZ.HTM exists.

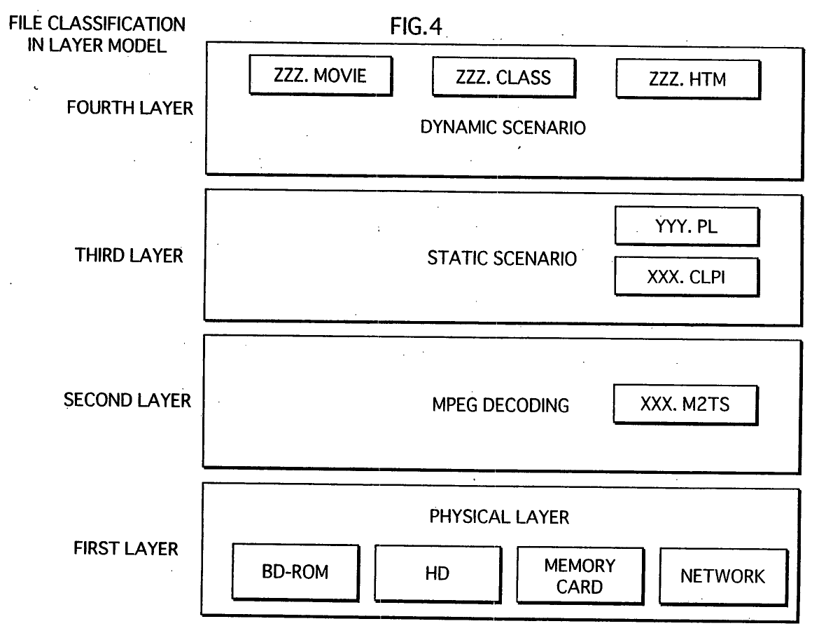

FIG. 4 is a classification diagram showing the classification of these files in a functional point of view. In this drawing, the layer structure, which is represented by the first, second, third, and fourth layers, symbolically represents the diagram's classification. In this drawing, “XXX.M2TS” is classified into the second layer. “XXX.CLPI” and “YYY.PL” are classified into the third layer (static scenario). “ZZZ.MOVIE” under the BDAV directory, “ZZZ.CLASS” under the JCLASS directory, and “ZZZ.HTM” under the BROWSER directory are classified into the fourth layer.

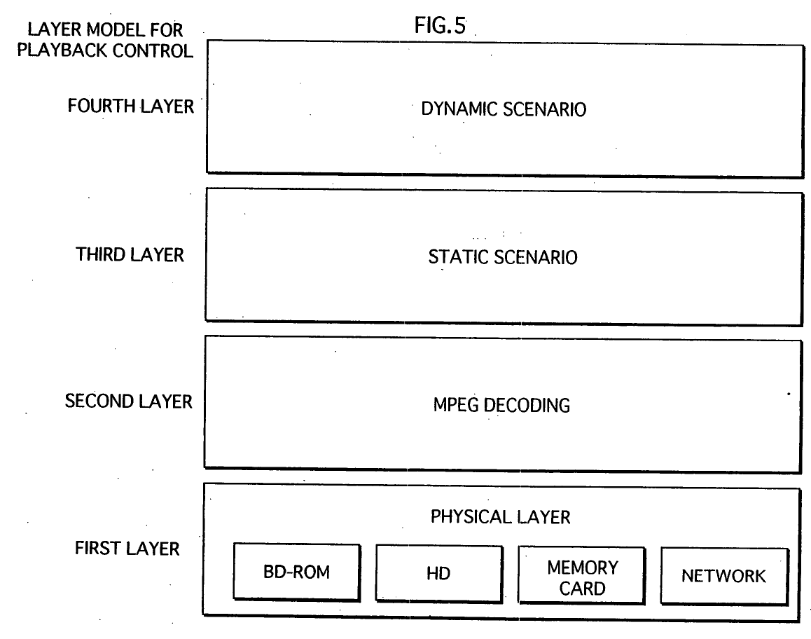

The classification in this drawing (i.e. the first to the fourth layers) targets a layer model shown in FIG. 5. The following explains the layer model for a control software program, which is the target of the BD-ROM, by referring to FIG. 5.

In FIG. 5, the first layer is a physical layer for controlling supply to the substance of a process-target stream. As shown by the first layer, the supply source of the process-target stream is not limited to a BD-ROM, and includes varieties of recording/communication media, such as HD, a memory card, and a network. The control performed by the first layer is directed to these supply sources (i.e. HD, memory card, network, etc.), and is specifically disc access, card access, and network communication.

The second layer is a layer for decryption method. The second layer defines in which decryption method the stream supplied by way of the first layer should be decrypted. The decryption method adopted by the present embodiment is a decryption method in MPEG2 standard.

The third layer (static scenario) defines a static scenario of a stream. A static scenario is comprised of playback path information and stream management information, which are predetermined by the manufacturer of the disc and the third layer (static scenario) defines the playback control based thereupon.

The fourth layer is for realizing a dynamic scenario in a stream. The dynamic scenario is for changing the playback progress according to a user operation and a state of an apparatus, and the fourth layer defines the playback control based thereupon. As follows, the substance of the stream (i.e. the files constituting the static scenario) is explained according to this layer model.

First, the stream belonging to the second layer (XXX.M2TS) is explained.

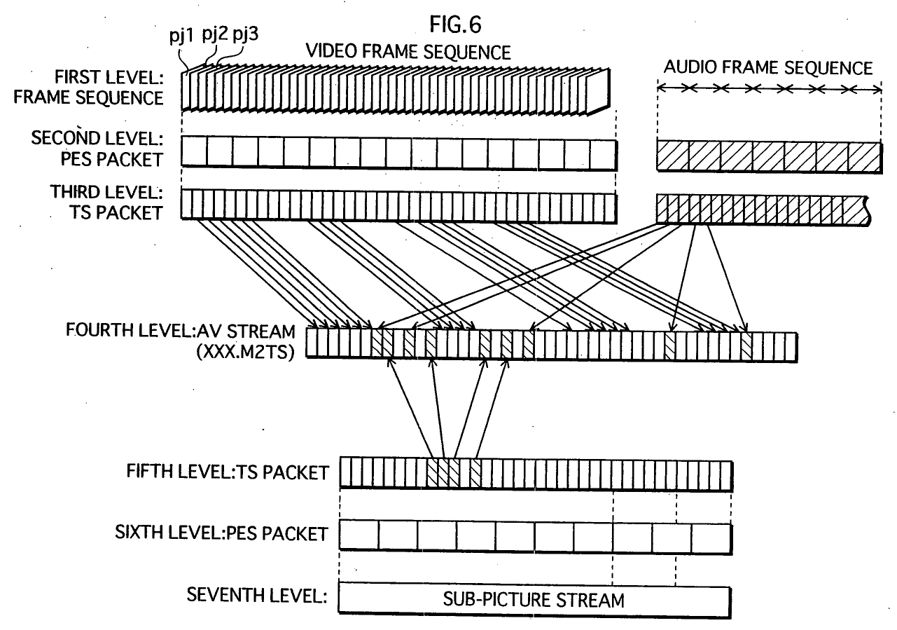

The AV stream (XXX.M2TS) is a digital stream in MPEG-TS (Transport stream) format, and is generated by multiplexing: a video stream; at least one audio stream; and at least one sub-picture stream. The video stream represents a moving picture portion of a movie work, the audio stream represents a sound portion of the movie work, and the sub-picture stream represents sub-titles of the movie work. FIG. 6 is a diagram schematically showing the structure of the AV stream.

The AV stream (fourth level) is generated as follows. A video stream made of video frames (picture pj1, 2, and 3), and an audio stream made of audio frames (first level) are converted into a PES packet sequence (second level), which is then converted into a TS packet sequence (third level). Likewise, a sub-picture stream (seventh level) is converted into a PES packet sequence (sixth level), which is then converted into a TS packet sequence (fifth level). The TS packet sequence (third level) and the TS packet sequence (fifth level) are then multiplexed, thereby completing the AV stream (fourth level). This multiplexing is actually to arrange video TS packets and audio TS packets so that a video TS packet and an audio TS packet to be read synchronously from the BD-ROM are positioned near to each other.

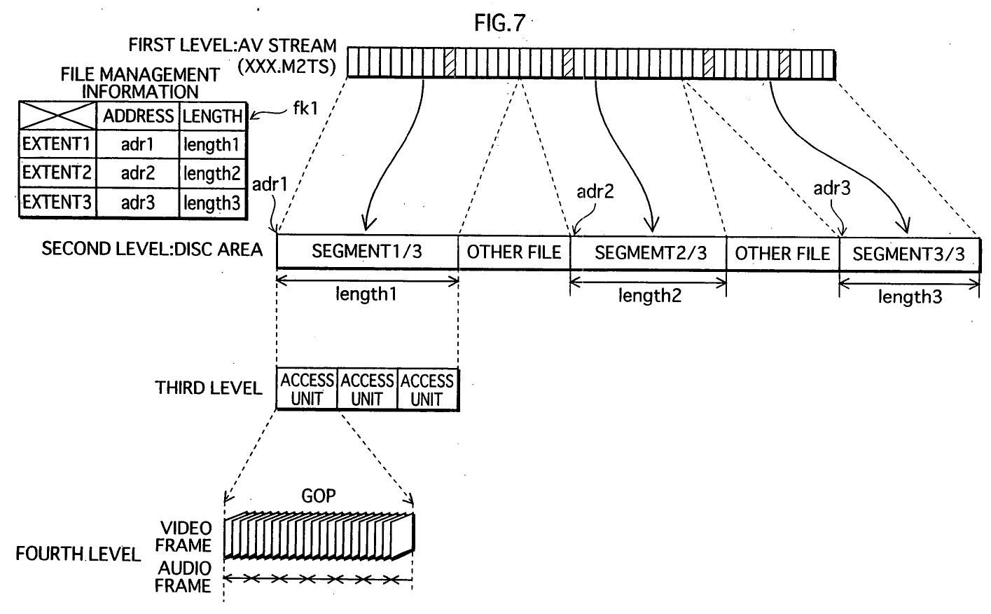

The AV stream generated by going through the aforementioned process is divided into a plurality of segments, just like a normal computer file, and is stored in an area of a BD-ROM. FIG. 7 is a diagram schematically showing how the AV stream is recorded into a BD-ROM.

The length and address in the BD-ROM, for a segment constituting the AV stream is described in file management information “fk1”.

In FIG. 7, in the file management information “fk1”, three segments obtained by dividing the AV stream are stored by being corresponded with the addresses (adr1, 2, 3) and the lengths (length1, 2, 3), respectively. The AV stream is comprised of one or more ACCESS UNITs, and is accessible in a unit of the ACCESSUNITs. The ACCESSUNIT is a minimum unit used in decoding, and includes one GOP (group of picture) and an audio frame to be synchronously read with the GOP. A GOP includes: a bidirectionally predictive (B) picture, a predictive (P) picture, and an intra (I) picture. The B picture is compressed using correlation with the image to be played back either before or after the picture. The P picture is compressed using correlation with the image to be played back before the picture. And the i picture is compressed using the spatial frequency response for one frame of image, without using correlations with other pictures.

Note that the file body “XXX” used in the file name “XXX.M2TS” represents an identification number in three digits assigned to an AV stream in a BD-ROM. In other words, the AV stream in this drawing is uniquely identified by this “XXX”. (Note that the three digits is only an example, and the identification number may be in any number of digits.)

<Static Scenario>

Next, “XXX.CLPI” and “YYY.PL”, each being a static scenario file, are explained.

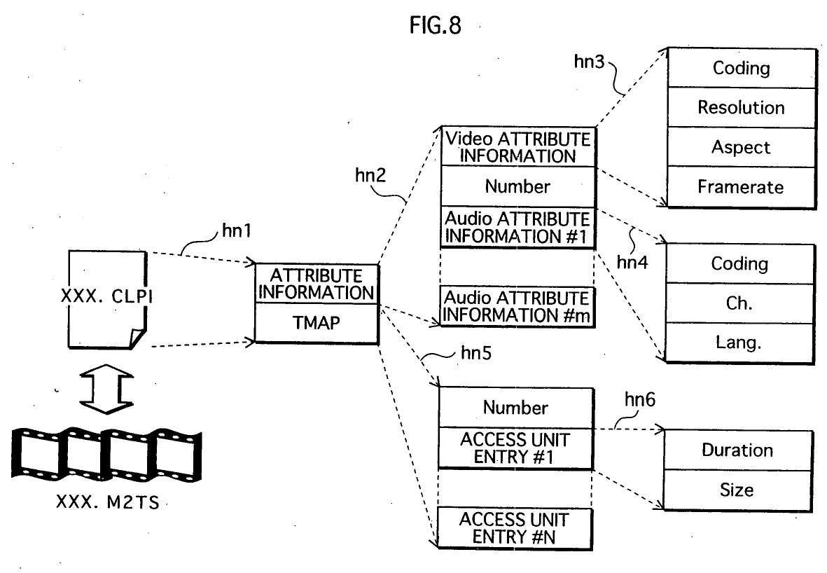

The stream management information (XXX.CLPI) is management information on each AV stream. FIG. 8 is a diagram showing the internal structure of the stream management information. An AV stream is generated by multiplexing a video stream and an audio stream, and is randomly accessed by the unit called “ACCESS UNIT”. Therefore, the management items included in the stream management information are attribute of each of the video stream and audio stream, and where each random-access point exists in the AV stream. The leader line in the drawing is for focusing on the structure of the stream management information. As shown by the leader line “hn1”, the stream management information (XXX.CLPI) is comprised of “attribute information” for each of the video stream and audio stream, and “TMAP” made of a reference table used in performing random access to the ACCESS UNITs.

As the leader line “hn2” shows, the attribute information (Attribute) is comprised of attribute information (video attribute information) and the number (Number) of attribute information, which relate to the video stream, and sets of attribute information (Audio attribute information #1-#m) for each audio streams multiplexed onto the AV stream. As the leader line “hn3” shows, the management information relating to the video stream indicates in which coding method the video stream has been coded (Coding), and resolution (Resolution), aspect ratio (Aspect), and a frame rate (Framerate) for each piece of picture data constituting the video stream.

On the other hand, as the leader line “hn4” shows, the attribute information for the audio stream (Audio attribute information #1-#m) indicates a coding method (Coding), channel number (Ch.) and language (Lang) for each audio streams.

The time map (TMAP) is a reference table used in indirect reference to a plurality of random-accessible addresses, using time information. As the leader line “hn5” shows, the time map is comprised of a plurality of pieces of entry information (ACCESS UNIT#1 entry information, ACCESS UNIT#2 entry information, ACCESS UNIT#3 entry information . . . ), and number of pieces of entry information (Number). Each piece of entry information is comprised of a playback duration (Duration) and a data size (Size) of a particular ACCESS UNIT. Adoption of a variable-length coding compression method enables random access from an arbitrary playback time to picture data within the ACCESS UNIT that corresponds to the playback time with use of this entry information, even when the ACCESS UNITs differ from each other in size or playback duration. Note here that the file body of the file name “XXX.CLPI” has the same name as adopted for the AV stream whose stream management information matches. In this drawing, for example, the file body of the AV stream is “XXX”, and so the stream management information “XXX.CLPI” corresponds to the AV stream (XXX.M2TS). Next, playlist information is explained.

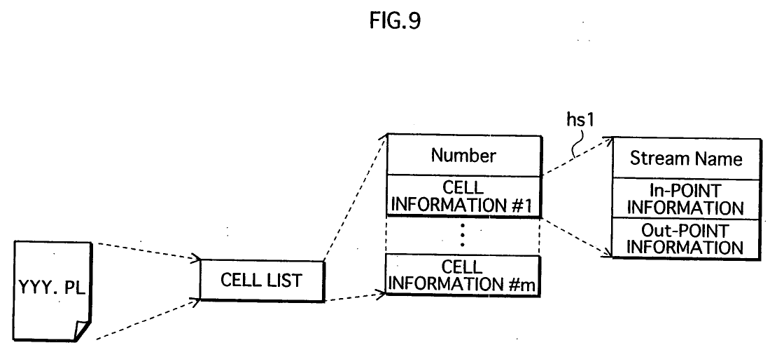

“YYY.PL” (Playlist information, hereinafter often abbreviated as PL information) is a table constituting a playlist (being a playback path), and is comprised of a CellList. FIG. 9 is a diagram showing an internal structure of the PL information.

The CellList is comprised of a plurality of pieces of CELL information (CELL information #1, #2, #3, . . . #n), and the number of the pieces of CELL information (Number). The CELL information is pointer information and is used to define at least one logical playback section that constitutes the playlist. The leader line “hs1” focuses on the structure of CELL information. As this leader line shows, the CELL information is comprised of “Stream Name” representing the name of the AV stream to which the In-point (start point) and Out-point (ending point) of a playback section belong, “In-point information” being information on the In-point of the playback section, and “Out-point information” being information on the Out-point of the playback section.

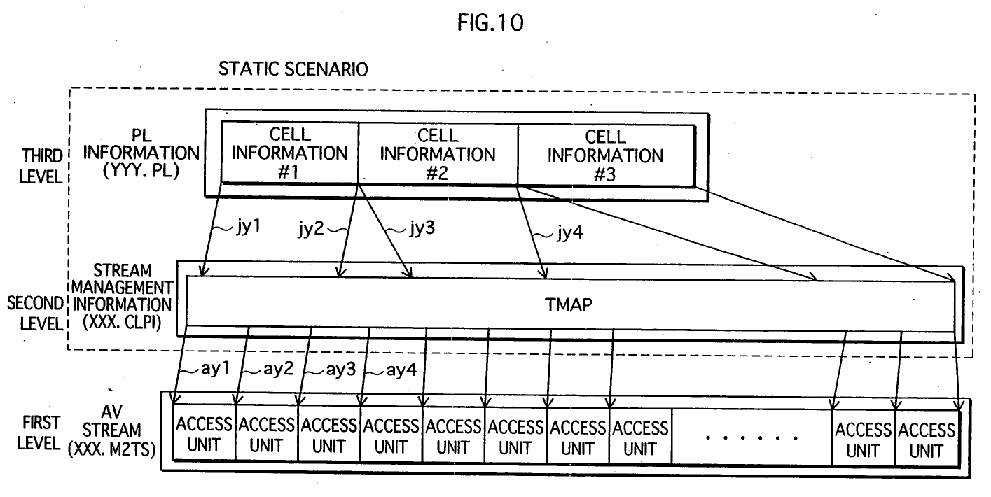

The CELL information is characterized by its notation. By CELL information, the playback sections are defined in a form of indirect reference using the time map as a reference table. FIG. 10 is a diagram schematically showing this indirect reference by means of PL information. In this drawing, the AV stream is comprised of a plurality of ACCESS UNITs. The TMAP within the stream management information indicates the sector addresses of the ACCESS UNITs, as shown by the arrows ay1, 2, 3, and 4. The arrows jy1, 2, 3, and 4, in this drawing, schematically show the reference to the ACCESS UNITS by means of CELL information. That is, the reference performed by means of the CELL information (i.e. the arrows Jy1, 2, 3, and 4) is interpreted as an indirect reference, by which the addresses of the ACCESS UNITs within the AV stream are identified via the TMAP.

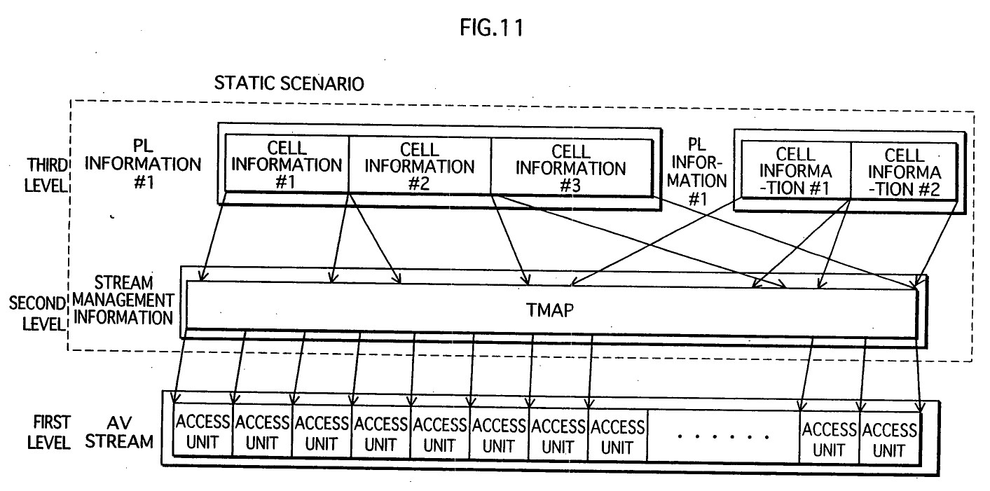

A playback section on a BD-ROM, which is represented by a set comprised of “CELL information-Stream management information-AV stream”, is called “Cell”. A logical playback unit on a BD-ROM, being a set comprised of “PL information-stream management information-AV stream”, is called “PL”. A movie work recorded on a BD-ROM is constituted by a collection of logical playback units (PL). Therefore, if a PL that specifies only scenes in which a certain character appears can be defined, it becomes possible to easily produce a movie work made of only such scenes, aside from the substance of the movie work itself. FIG. 11 is a diagram showing one example of defining a different PL (PL information #2) from the PL information (PL information #1) that is shown in FIG. 10.

Only by defining a variety of PL information, it becomes possible to increase a number of movie works, and to broaden movie producers' expressions. This is the largest advantage of the static scenario.

A BD-ROM has another playback unit called “Chapter”, in addition to “PL”, “CELL” and the like. A chapter is made of one or more CELLs.

Note that the file body “YYY” used in the file name of PL information represents an identification number in three digits assigned to PL information for a BD-ROM. In other words, the PL information in this drawing is uniquely identified by this identification number “YYY”. The reason why the identification number of PL information is expressed as “YYY” is to indicate that this identification number system is different from the identification number system “XXX” assigned to AV stream and AV stream management information. (Note that the three digits is only an example, and the identification number may be in any number of digits.)

Next, the following describes a dynamic scenario.

<Dynamic Scenario>

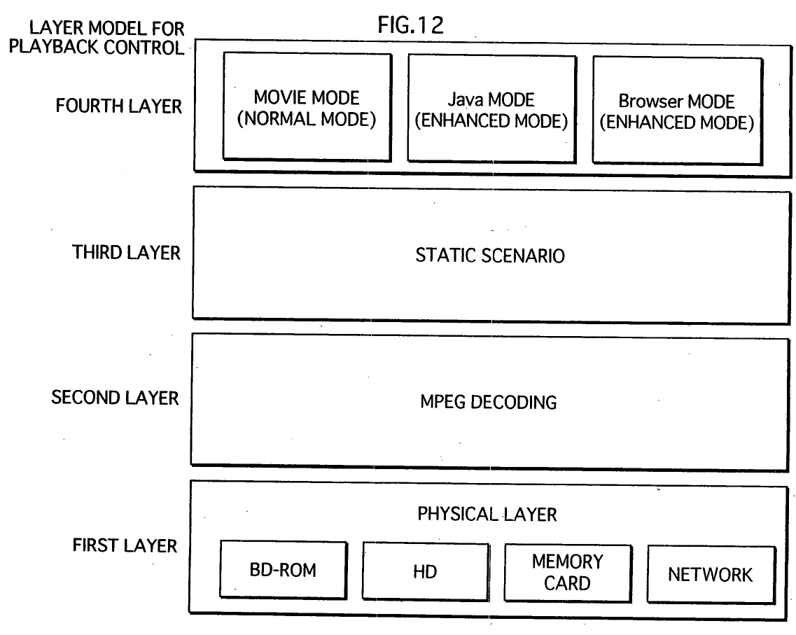

The following describes “ZZZ.MOVIE”, “ZZZ.HTM”, and “ZZZ.CLASS”, each being a dynamic scenario. A dynamic scenario indicates a playback control procedure for an AV stream. The playback control procedure is changed according to a user operation directed to an apparatus, and has a program-like characteristic. There are two modes of dynamic playback control. The one mode is called “normal mode” in which moving image data in a BD-ROM is played back in a playback environment unique to an AV apparatus. The other mode is called “enhanced mode” by which the additional value of moving image data in a BD-ROM is enhanced. FIG. 12 is a diagram showing a playback mode in the fourth layer of the layer model. In the fourth layer of this drawing, one normal mode and two enhanced modes are described. One normal mode is a playback mode in a playback environment that is DVD-like, and is called “MOVIE mode”. One of the two enhanced modes is a playback mode whose substance is a Java virtual machine, and so is called “Java mode”. The other one of the two enhanced modes is a playback mode whose substance is a browser, and is called “Browser mode”.

Note that the file body “ZZZ” used in the file names “ZZZ.MOVIE”, “ZZZ.CLASS”, and “ZZZ.HTM” represents an identification number in three digits assigned to a dynamic scenario. In other words, the scenario in this drawing is uniquely identified by this identification number ZZZ. The reason why the identification number of the scenario is expressed as “ZZZ” is to indicate that this identification number system is different from the identification number system “XXX” assigned to an AV stream, and from the identification number system “YYY” assigned to PL information. (Note that the three digits is only an example, and the identification number may be in any number of digits.)

The following describes dynamic scenarios for the modes in greater detail.

“ZZZ.MOVIE” is a dynamic scenario directed to a MOVIE mode. Using this dynamic scenario, a playback control very similar to that of an existing DVD playback apparatus is enabled on a playback apparatus.

“ZZZ.HTM” is a dynamic scenario directed to a Browser mode. Using this dynamic scenario, it becomes possible to describe a control procedure such as accessing a site on a network, and downloading a file.

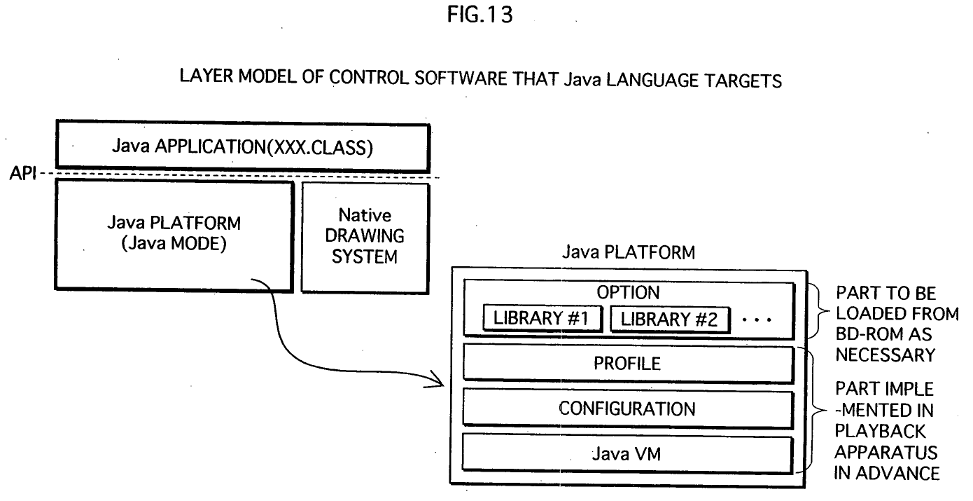

“ZZZ.CLASS” is a dynamic scenario directed to a Java mode, and is an application program in Java language. Being an application program in Java language, this dynamic scenario's substance is a Java platform. The following details the relation between the Java mode's application and the Java platform with reference to FIG. 13. FIG. 13 is a diagram showing the layer model of the Java platform that the Java language targets. The application in Java mode is positioned at the highest-order layer of the layer model. Directly under this Java mode application, API (Application Interface) is positioned. Under the API, the Java platform is positioned. A native drawing system is an image drawing function that a playback apparatus is naturally equipped with, and is positioned at the same layer as the Java platform.

The Java platform is comprised of “Java virtual machine (JavaVM)”, “configuration”, “profile”, and “option”.

The Java virtual machine converts the Java mode application, having been described in Java language, into a native code for CPU of the playback apparatus, and makes the CPU execute the native code. The configuration realizes simple input/output at the playback apparatus, and the profile performs IP communication, screen drawing, and the like at the playback apparatus.

The option includes a variety of libraries. These libraries are used to supply a variety of functions, which cannot be supplied from the Java platform, to the application in Java mode. More specifically, these libraries define processing for ensuring security of the playback apparatus, and input/output between BD-ROM and Java application.

The Java virtual machine, the configuration, the profile, and the native drawing system are to be implemented in the playback apparatus in advance. In addition, the control software programs of the first to third layers shown in FIG. 12 are also to be implemented in the playback apparatus in advance. However the option should be read from a BD, because there are varieties of options that the Java mode application will require, and it is impossible to implement all these options in the playback apparatus in advance.

The interleave unit “ILUsss.CLASS” is an interleave-recorded file, and stores therein programs, libraries, and the like. A program in the ILUsss. CLASS is a byte code sequence in which processing unique to an application is described, and functions as the substance of the application. A library in the ILUsss.CLASS is a program that is treated as a component, and is a byte code sequence usable by a variety of applications.

The following details such a library. The library in the present embodiment has a live range on a playback time axis of an AV stream (PL). Here, what is meant by a live range is a duration on a playback time axis of an AV stream (PL), during which an application is allowed to use the particular library.

Specifically, an application uses a library by having the Java virtual machine to execute a function included in the library according to a call made by the application directed to the function. There is an important condition to be satisfied for library execution by the Java virtual machine. The condition is to load the library in the work area (heap area) inside the Java virtual machine. In light of this, before library use, it becomes necessary to issue an instruction for loading the library from the cache memory of the playback apparatus to the work area of the Java virtual machine. Here, if the file has been read from the BD-ROM to the cache memory of the playback apparatus in advance, the mentioned loading instruction will be normally ended. On the other hand, if the library has not been read to the cache memory of the playback apparatus, the loading instruction will be exceptionally ended (error ending). If the normal ending is hoped, it is desirable to read the library file to the cache memory of the playback apparatus. By doing so, it becomes possible to load the library from the memory of the playback apparatus to the work area of the Java virtual machine, at any time.

Here, defining of a live range of the library is considered as identical to reading of the library to the cache memory of the playback apparatus. However, in a hardware specification of consumer appliances such as a BD-ROM playback apparatus, a memory therein is small. Therefore if there are many libraries to be used, it becomes necessary to restrain a live range for each library to be of a minimum length.

The following describes how to define a live range.

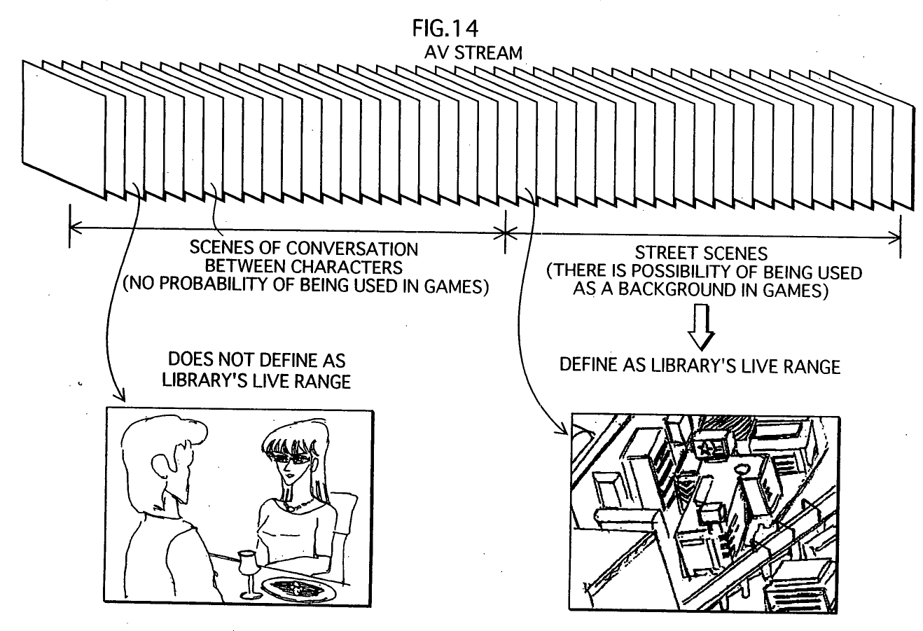

FIG. 14 is a diagram showing an AV stream that is to be a target of live range setting. In programming a game application that is to be synchronously played back with the AV stream, it is preferable to define, as a live range, a duration in which frequent use of library by the application program is expected, for a reason such that a particular image continually appears. This is because then it becomes possible to execute a variety of libraries synchronously with playback of the AV stream. For example, the AV stream shown in FIG. 14 is originally meant to constitute a movie work, and includes scenes for example of conversation between appearing characters and of street scenes. Among them, such a kind of scenes as street scenes has extremely high probability of being used for a background when the game application renders computer graphics. If such a duration on the AV stream is defined as a live range of a library, so that the library is ready to be read to a memory of the playback apparatus during this live range, then the library is assured to be loaded to the work area when the application program issues the loading instruction. In light the above, for defining live ranges, it becomes necessary to understand at which time on the playback time axis of the AV stream, scenes are required to be synchronized with libraries (e.g. background of an application program), in the pre-authoring stage. Also an important thing to remember in the decision of a live range for each library is to avoid overlapping of live ranges between the libraries.

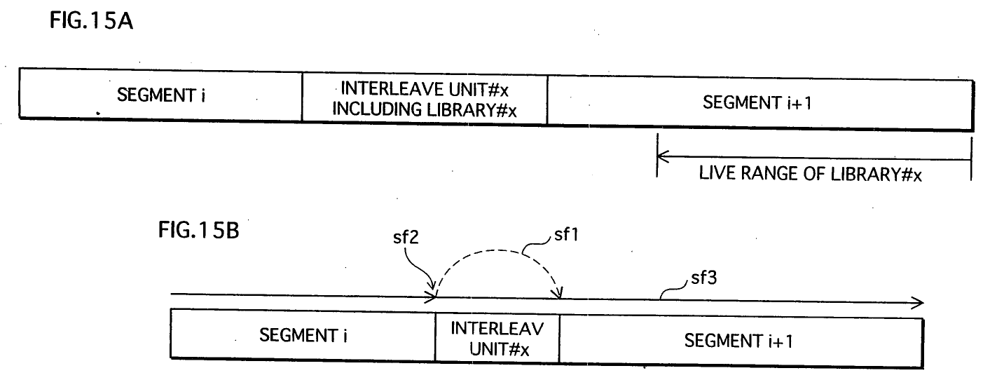

Next, interleave recording, which is a recording embodiment of a library, is explained. Interleave recording is to record objects to be recorded in a BD-ROM, between segments constituting an AV stream. In the example of FIG. 7, interleave recording is to record objects to positions each corresponding to “other file”. Each object subjected to this interleave recording is referred to as “interleave unit”. The following describes how a library is recorded, when the library is the object to be subjected to interleave recording. When a library is an interleave unit, it is recorded immediately ahead of a segment that includes IN-point of the live range of the library. FIG. 15A is a diagram showing how the segments are recorded into a BD-ROM. Here, an AV stream is divided into a plurality of segments. If the segment i+1 includes the IN-point of the live range of a certain library #x, then the interleave unit including the library #x is recorded immediately ahead of the segment i+1. As above, an interleave unit has a characteristic of being recorded immediately ahead of the segment including the In-point of the corresponding live range.

The interleave unit #x and the segment i are recorded as shown in FIG. 15A. Therefore reading of the segment is performed as shown in FIG. 15B. FIG. 15B shows a read path by way of an optical pickup, when the segment i and the segment i+1 are successively read. Originally, so as to read the segment i+1 after the segment i has been read, a pickup has to perform a seek as shown by a broken-line arrow “sf1”. However an interleave unit exists ahead of the segment i+1. The interleave unit includes a library having a live range during the playback duration of the segment i+1. “sf2” is an optical-pickup reading position when there is a preceding interleave unit #x. “sf3” indicates a disc scan by way of an optical pickup. As a result of this disc scan “sf3”, the interleave unit #x and the segment i+1 will be read in succession after the segment i has been read, without seek.

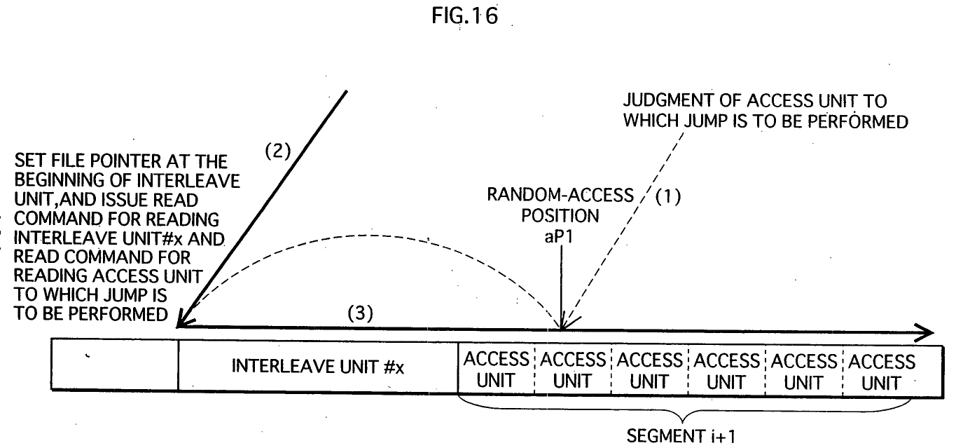

FIG. 15B shows the case where successive reading is performed for the segments constituting one AV stream. Next, how an optical pickup reading is performed when a random access is performed to the segment including the live range of a library, with reference to FIG. 16.

FIG. 16 is a diagram showing a moving path of an optical pickup when a random access is performed to the segment i+1. In moving the optical pickup to the random-access position “aP1” in the drawing, it is judged whether there is an interleave unit preceding the segment i+1. (2) indicates an optical-pickup reading position when there is a preceding interleave unit, and (3) indicates a disc scan performed by the optical pickup. When there is an interleave unit preceding the segment, an optical-pickup scan is performed from the beginning of the interleave unit to the segment, so that the playback apparatus can read the interleave unit and the segment. By moving the optical pickup in this way, one scan (3) by the optical pickup is sufficient for reading the ACCESS UNITs required for a moving picture playback, and the library related therewith, at the same time.

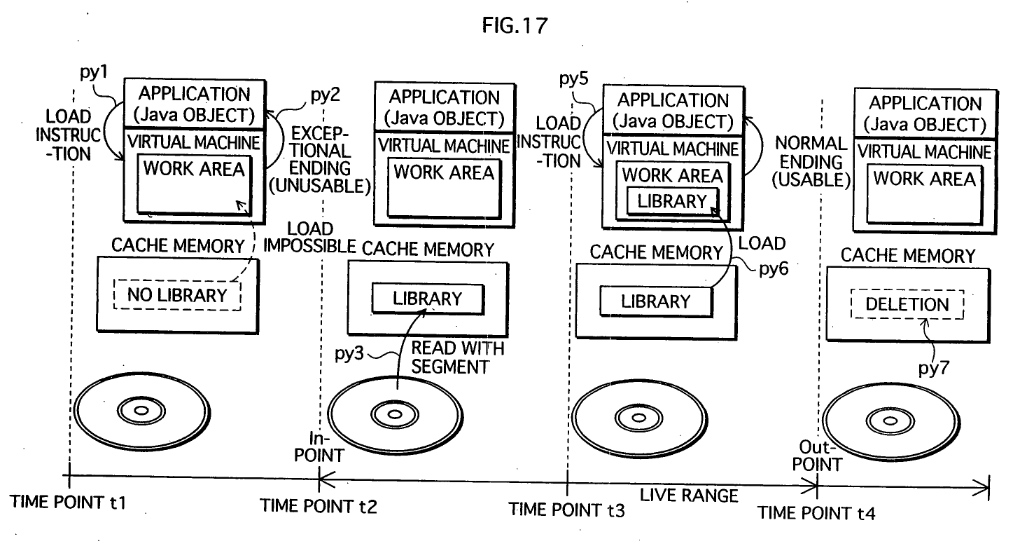

Since a library is stored in a form of interleave unit, the library is read to a memory at a time when the current playback time point reaches the corresponding live range. Therefore, if an application program issues a loading instruction during the live range, the loading from the memory of the playback apparatus to the work area of the Java virtual machine is assuredly performed. FIG. 17 is a diagram showing how 1) reading of a library to the memory, and 2) loading of the library to the work area of the Java virtual machine, are performed at each time points (t1, t2, t3, and t4) on the playback time axis of the AV stream.

The time point t1 is positioned outside the live range of the library. Therefore the library has not been read to the cache memory, and so loading of the library is impossible even if the application program issues a loading instruction as shown by the arrow “py1”. Accordingly, the loading will be exceptionally ended as shown by the arrow “py2”.

The time point “t2” corresponds to IN-point of the live range of the library. Since the current playback time point has reached the IN-point of the live range, the library will be read to the memory as the arrow “py3” indicates.

The time point “t31” is within the live range of the library, and corresponds to a time point at which the application program has issued a loading instruction. Since the memory stores therein the library, the library can be loaded to the work area of the Java virtual machine according to the loading instruction issued by the application program (arrow “py6”). By the above construction, the application program can freely call the function from the library.

The time point “t4” is within the library's live range. Since the current playback time point has reached OUT-point of the live range, the library will be deleted from the memory as the arrow “py7” indicates. Therefore even if the application program issues a loading instruction hereafter, the loading instruction will be exceptionally ended just as the at the time point “t0”.

Next, the internal structure of an interleave unit is described.

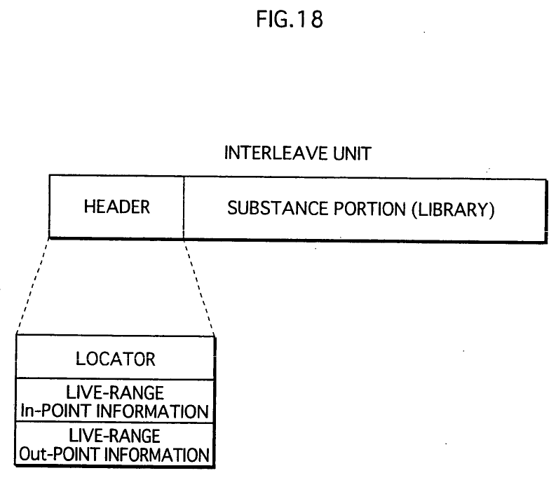

FIG. 18 is a diagram showing the structure of an interleave unit. As shown in this drawing, an interleave unit is comprised of a header and a substance portion. In the present embodiment, the substance portion corresponds to a library.

The header includes: “locator” indicating where in the memory the library (substance portion) exists; “live-range IN-point information” indicating a time point that corresponds to IN-point of the live range of the library; and “live-range OUT-point information” indicating a time point that corresponds to OUT-point of the live range of the library. The locator is provided so as to identify a library within the memory of the playback apparatus. The library is assigned a header in which information relating to the live range is described, and is recorded in a form of an interleave unit, to a BD-ROM.

The following describes the technical meaning of providing such a locator. Suppose it is wished that a library included in an interleave unit be treated as a file “J001.CLASS” under the Java directory. In this case, the locater is described as “CM://Java/J001.CLASS”, where “CM://” indicates that the interleave unit is stored in a cache memory in the playback apparatus. On the contrary, if the interleave unit is stored in a hard disc the locator should be described as “HD://”. “Java/J001.CLASS” indicates a file path of the storage place of the interleave unit. The playback apparatus, when reading the interleave unit, creates/opens the Java directory and the file “J001.CLASS” on the cache memory, and stores the library included in the interleave unit, to the file “J001.CLASS” under the Java directory. By doing so, the application program is able to indicate the library on the cache memory using the file path “Java/J001.CLASS”, when ordering the library transfer from the cache memory to the work area of the Java virtual machine.

The following describes the technical meaning of providing “live-range IN-point information” in a header of an interleave unit. The start point of a live range included in an interleave unit is principally a time point of the playback time axis of the AV stream, at which the corresponding library exists on a memory. However the live-range IN-point information of a header can describe another point different from the above-mentioned time point. This is for taking into consideration the following case. In some method of programming in Java language, use of libraries is not allowed for an application program, if only one of the three libraries is in the memory. Use of libraries is allowed for an application program only when all the three libraries are ready in the memory. However in the case where the three libraries are stored in separate places on a BD-ROM as three interleave units, the three libraries are read to the memory at a different time from each other. In such a case, it becomes necessary to prohibit an application program from library use if one or two libraries are on the memory. Therefore live-range IN-point information in each interleave unit's header is set to a time point at which the three libraries are ready in the memory.

By the above arrangement, even when one or two of the three libraries have been ready on the memory, the libraries are not ready for use. The libraries are only ready for use when the third library is ready on the memory. By providing such live-range IN-point information in each header of libraries, it becomes possible to synchronize the time at which all the three libraries are ready for use, even when the libraries are dispersed in the BD-ROM.

Next, the following describes the technical meaning of providing “live-range OUT-information”. As described above, the hardware specification of a BD-ROM playback apparatus is limited in memory size. Therefore if various libraries are attempted to be stored in the cache memory, overwriting library on library occurs, which then leads to a possibility of hang-up. To prevent such, it becomes necessary to promptly delete, from the cache memory, libraries whose live range has become obsolete. “Live-range OUT-point information” is described in a header of each live range so as to facilitate such deletion.

Next, the notation of live-range IN-point information and live-range OUT-point information is described. Here, the playback time axis of an AV stream is a time axis that functions as a reference for deciding playback timing of each video/audio frames, and decoding timing of each video frames, where the video frames and the audio frames respectively compose a video stream and an audio stream, which are multiplexed into the AV stream. A position on such a playback time axis is expressed as a value relative to time information of the first video frame within the AV stream. Since playback timing and decoding timing are defined on the playback time axis, synchronous playback of the audio frames and the video frames is enabled. Here, note that IN-point/OUT-point of a live range are also respectively considered as a point on a playback time axis. Therefore a live range is also expressed as a value relative to time information of the first video frame within the corresponding video stream. Accordingly, the above-described live-range IN-point information and live-range OUT-point information respectively indicate IN-point and OUT-point of a live range, using a value relative to the time information of the first video frame of the video stream.

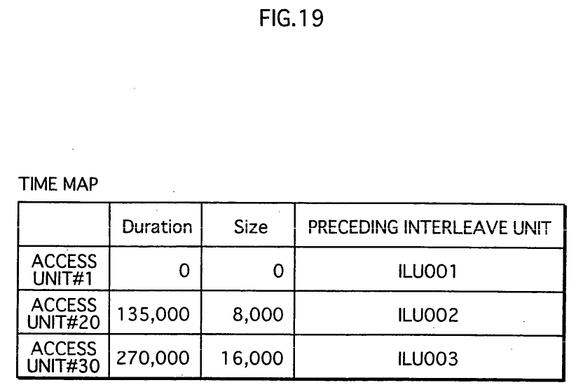

So as to perform random access to an ACCESS UNIT, the following improvement is necessary for reading ACCESS UNIT—interleave unit, at once. Among the segments, as for an ACCESS UNIT that is immediately after an interleave unit, the entry of the ACCESS UNIT in the TMAP should be modified as shown in FIG. 19. FIG. 19 is a diagram showing the improvement for the ACCESS UNIT entry in the TMAP. In this drawing, the ACCESS UNIT entries relate to ACCESS UNITs respectively immediately after an interleave unit. What is characteristic in this drawing is that the entries for the ACCESS UNITs#1, #20, #30, being positioned at the beginning of segments, respectively store the file bodies (ILU001, ILU002, ILU003) of the file names of interleave units. These interleave units respectively precede a corresponding segment. By storing the file names of such interleave units in the ACCESS UNIT entries, it becomes possible to efficiently perform processing for reading the ACCESS UNITs at the beginning of the segments and the interleave units, all together.

Note that “sss” in the “ILUsss.CLASS” represents three-digit identification number assigned to an interleave unit in a BD-ROM. That is, the interleave units in this drawing are uniquely identified using “sss”. The reason why the identification number of an interleave unit is expressed as “sss” is to indicate that this identification number system is different from the identification number system “XXX” assigned to an AV stream and AV stream management information, and from the identification number system “YYY” assigned to playlist information, and further from the identification number system “ZZZ” assigned to a dynamic scenario. (Note that the three digits is only an example, and the identification number may be in any number of digits.)

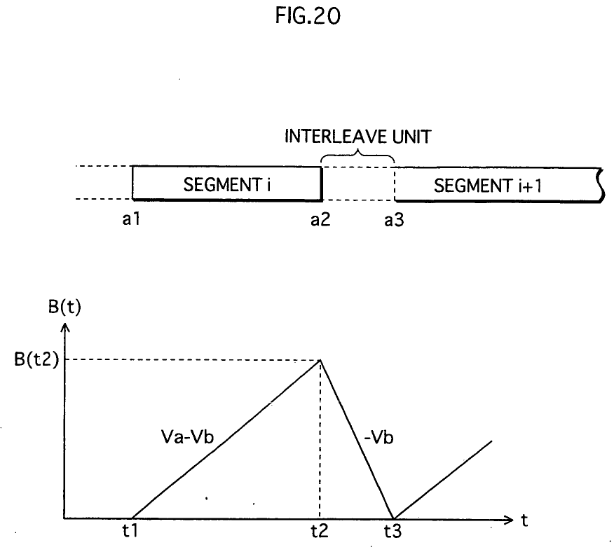

Next, the continuous length of each segment is described. In dividing an AV stream, care should be taken to prevent underflow of a buffer from which a segment is read (the buffer being called “track buffer”), in recording of the AV stream. The upper level of FIG. 20 shows one of the segments constituting an AV stream. The segment occupies an area of a BD-ROM from the position “a1” to the position “a2”. The graph at the lower level of FIG. 20 shows a state transition of a track buffer when this segment is read out. In this graph, the horizontal axis represents a time axis, and the vertical axis represents an accumulated amount in the track buffer. The state transition shown by this graph is made up of a simple increase portion (increase rate of Va−Vb) and a simple decrease portion (decrease rate of −Vb). The simple increase corresponds to a time period from the time point “t1” to the time point “t2”, and the simple decrease corresponds to a time period from the time point “t2” to the time point “t3”. Here, the time point “t1” corresponds to the read time point “a1”, and the time point “t2” corresponds to the read time point “a2”. The time point “t3” corresponds to the read time point “a3”. Va represents a speed of inputting to the track buffer, and Vb represents a speed of outputting from the track buffer. At the time point “t2”, the accumulated amount “B(t2)” of the track buffer is expressed as follows:
B(t2)=(Va−Vb)*(t2−t1) (expression 1)

When the track buffer to which the segment is to be read changes in state as shown above, the increase amount “B(t2)” from “t1” to “t2” should exceed the decrease amount “Vb(t3−t2)” from “t2” to “t3” as indicated by the following expression 2, so as to avoid underflow. If the continuous length of the segment is decided so that the expression 2 is satisfied, the track buffer underflow will not occur.
B(t2)≧Vb*(t3−t2) (expression 2)

Next, programs stored in “ILUsss.CLASS” are explained. The difference between the programs stored in “ILUsss.CLASS” and the applications of “ZZZ.CLASS” is that “ZZZ.CLASS” is limited to processing of describing playback control directed to a dynamic scenario, and so does not have live ranges. Whereas the applications of “ILUsss.CLASS” are not limited to playback control directed to a dynamic scenario, and are able to describe varieties of control such as game/client processing, and so have live ranges. (Needless to say, a program in “ILUsss.CLASS” may have a code for playback control.) A live range of a program in “ILUsss.CLASS” is a section that other applications (including an application stored in “ZZZ.CLASS”) can call. Therefore “ILUsss.CLASS” storing the program is recorded ahead of the IN-point of the corresponding live range by interleave-recording. By doing so, the program in “ILUsss.CLASS” will be read to a memory 14 and then transferred to the work area of the Java virtual machine, before being called by the application of “ZZZ.CLASS”.

The mentioned interleave recording has a prior technology, called “multiplexing”. Compared to multiplexing to an AV stream, interleave recording shown by the present embodiment has the following advantages. In multiplexing, a library is embedded to the AV stream together with a video stream and an audio stream, and so it becomes necessary to allocate the band for a library, being non-AV data, in advance. In other words, so as to read a library together with video/audio streams, it is necessary to restrain the band originally for the video stream, so as to allocate a band for reading the library. In the case of a movie work, this narrows the band for the image/sound, which degrades the quality of either the image or the sound. So as to allocate an optimal band for libraries in an attempt to prevent the image/sound bands from being narrowed, it then is necessary to multiplex the AV stream for each country's language. This is a very troublesome work for a movie work production.

As opposed to this, when libraries are stored in a BD-ROM using interleave recording, the libraries are recorded as independent files. Therefore even if the interleave units are placed between the segments, the interleave units are considered as a continuous file. Accordingly, the multiplexing process for an AV stream generation is another process from that for the library creation, which reduces the load in the authoring stage.

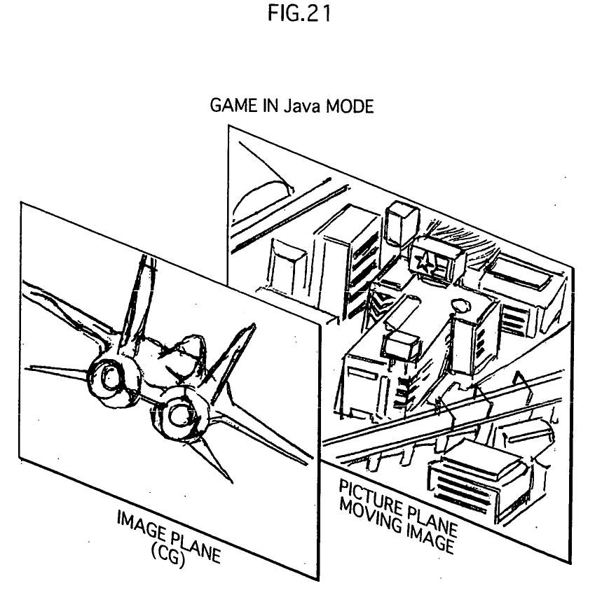

The following describes a setting example of interleave unit, with reference to FIGS. 21-24. This setting example assumes creation of a game program as shown in FIG. 21. The game program of FIG. 21 is an overlaid image made of: a moving image from a movie work as the background; and computer graphics as the foreground. The computer graphics being the foreground is an airplane, whose attitude and direction is controllable according to a user operation.

On the other hand, the moving image being the background is an image of a city photographed from up in the sky. Since the overlaid image therebetween is displayed to a user, the user is able to experience a realistic flight simulation. From a software control point of view, the application in Java mode should render computer graphics in synchronization with playback of the AV stream.

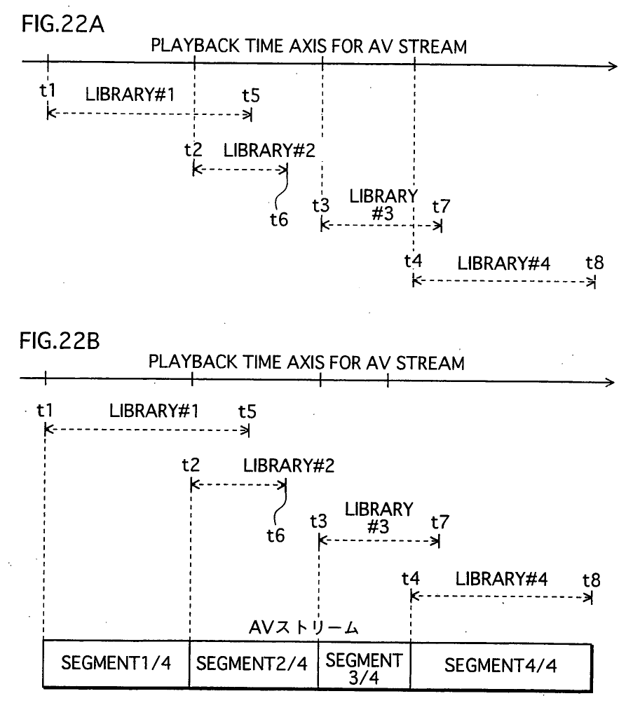

The example explained here assumes to have four libraries (#1, #2, #3, #4) having live ranges as shown in FIG. 22A. These libraries are specifically: a rendering library for creating a projection image of the shape data of the airplane; a texture mapping library for attaching, to the projection image, a texture pattern representing the appearance pattern of the airplane; a shading processing library for providing the projection image with shade/shadow. FIG. 22A is a diagram showing the live ranges respectively for the libraries #1, #2, #3, and #4. The vertical axis of this drawing corresponds to a playback time axis of an AV stream, along which the live ranges for the libraries are drawn. The live range of the library #1 has the earliest IN-point among all the libraries #1, #2, #3, and #4. Thereafter, the IN-points of the live ranges for the libraries #2, #3, and #4 follow. As for the OUT points, the OUT-point of the live range of the interleave unit #1 is the earliest, and then the OUT-points of the interleave units #2, #3, and #4 follow.

The AV stream constituting a moving image is divided into four segments (i.e. Segment 1/4, Segment 2/4, Segment 3/4, Segment 4/4), and stored in a BD. Each boundary between segments in an AV stream corresponds to an IN-point of a live range of a library. FIG. 22B is a diagram showing the relation between the IN-points of the live ranges of libraries and segments. The boundaries between segments (shown by broken lines) are set a little ahead of the IN-points of the live ranges of the corresponding libraries #1, #2, #3, and #4. In other words, an AV stream is divided by IN-points of live ranges of libraries.

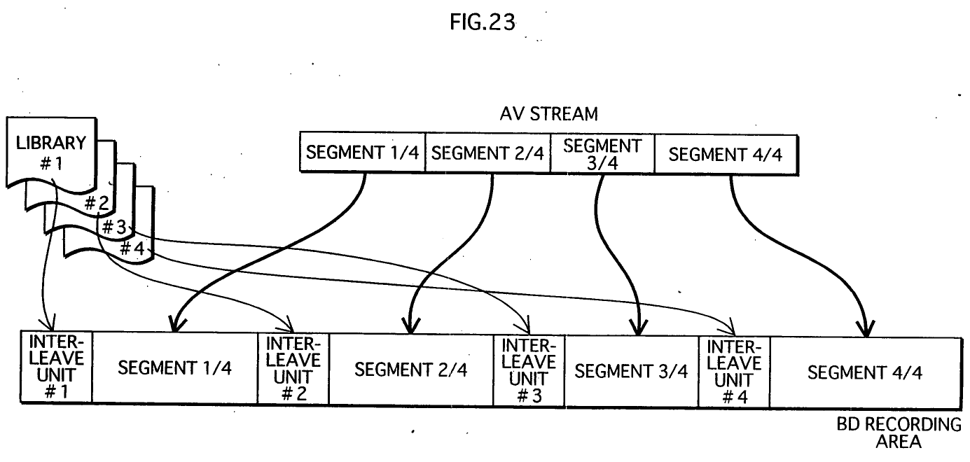

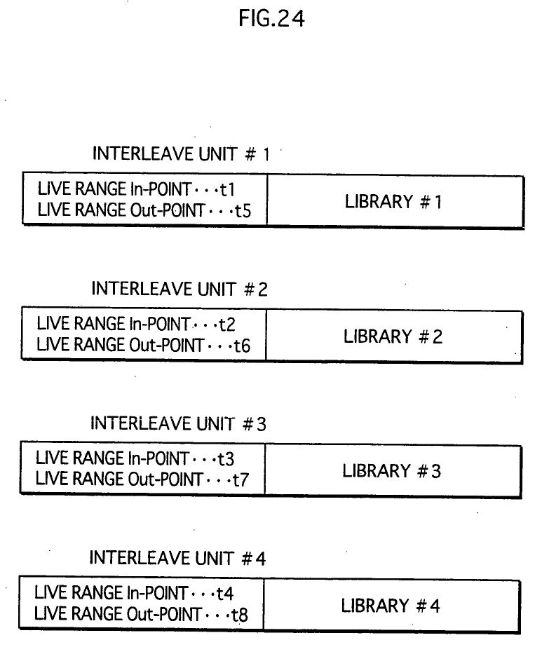

FIG. 23 shows in what manner each segment is recorded in the BD. Here, interleave units are recorded as follows: the interleave unit #1 is positioned ahead of the segment 1/4; the interleave unit #2 is positioned between the segment 1/4 and the segment 2/4; and the interleave unit #3 is positioned between the segment 2/4 and the segment 3/4. FIG. 24 is a diagram showing the internal structure of the interleave units. Each interleave unit is made of a header and a library, the library being a substance portion (i.e. libraries #1, #2, #3, #4), and the header indicating the IN-point and the OUT-point of the live range of a corresponding one of the libraries #1, #2, #3, and #4.

By recording the interleave units and the segments as shown in FIG. 23, each library is read onto a memory immediately ahead of the live range of the library. In addition, since the header of each interleave unit shows the OUT-point of the live range, a library in the memory will be deleted when the playback time point of the AV stream reaches the OUT-point of the library's live range. With such control being realized, sufficient memory resource for a playback apparatus will be reduced. The playback apparatus requires its maximum memory resource during the period where two live ranges overlap, in such a case the playback apparatus only has to have the amount sufficient for allowing corresponding libraries to be resident therein. This means that it is possible to calculate a minimum necessary size of a memory from the live ranges of the libraries, thereby deciding a recommended memory size satisfying the calculated size. By doing so, the operating environment can be made similar to that of the hardware specification of a BD playback apparatus.

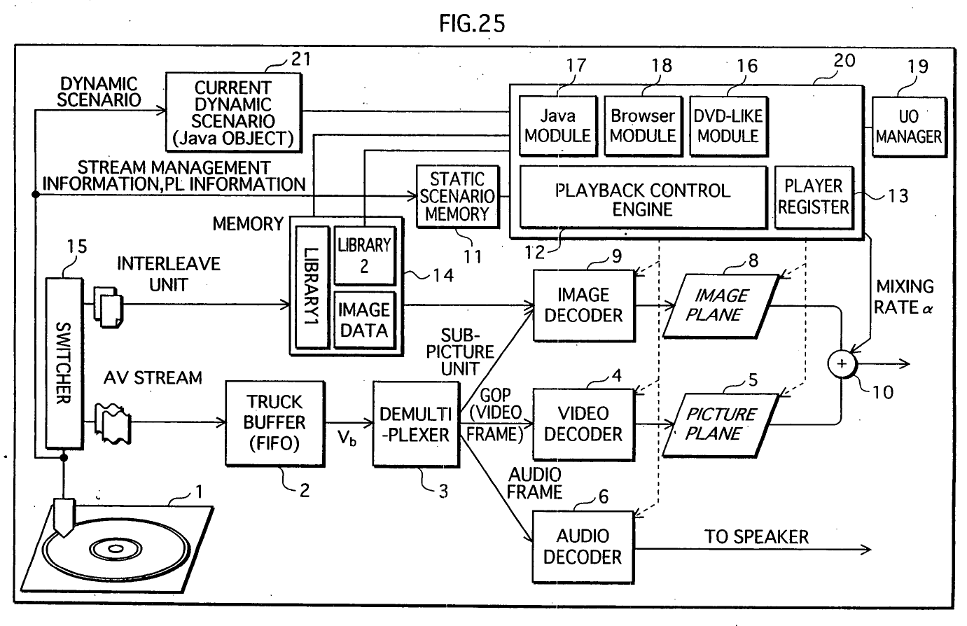

Next, the embodiment of a playback apparatus relating to the present invention is described. FIG. 25 is a diagram showing an internal structure of a playback apparatus according to the present invention. As this diagram shows, the playback apparatus is made up of a BD drive 1, a track buffer 2, a demultiplexer 3, a video decoder 4, a picture plane 5, an audio decoder 6, an image plane 8, an image decoder 9, an adding device 10, a static scenario memory 11, a playback control engine 12, a player register 13, a memory 14, a switcher 15, a DVD-like module 16, a Java module 17, a browser module 18, an UO manager 19, and a track buffer 21.

The BD-ROM drive 1 performs loading/eject of a BD-ROM, and makes an access to an BD-ROM.

The track buffer 2 is a FIFO memory, and stores the ACCESS UNITs read from a BD-ROM in the first-in first-out basis. When the input speed to the track buffer 2 is Va and the output speed thereof is Vb, the buffer state of the track buffer 2 will be as shown by the graph of FIG. 20.

The demultiplexer 3 performs demultiplexing by taking out the ACCESS UNITs from the track buffer 2, obtains the video frames and the audio frames that constitute a GOP, and outputs the video frames to the video decoder 4, and the audio frames to the audio decoder 6. The sub-picture units constituting the sub-picture stream are outputted to the image decoder 9. The demultiplexing performed by the demultiplexer 3 includes conversion processing for converting TS packets into PES packets.

The video decoder 4 decodes the video frames outputted from the demultiplexer 3, thereby writing resulting non-compressed pictures to the picture plane 5.

The picture plane 5 is a memory for storing therein non-compressed pictures.

The audio decoder 6 decodes the audio frames outputted from the demultiplexer 3, thereby outputting resulting non-compressed audio data.

The image plane 8 is a memory having an area for a screen, to which images to be displayed (e.g. computer graphics and subtitles) are placed.

The image decoder 9 is a constituting element that corresponds to the native drawing system shown in FIG. 13. The image decoder 9 decompresses the sub-picture stream outputted from the demultiplexer 3, and writes the decompressed sub-picture stream to the image plane 8. In addition, the image decoder 9 renders computer graphics according to an instruction from the Java virtual machine, and writes the computer graphics to the image plane 8.

The adding device 10 overlays the images developed on the image plane 8, onto the non-compressed picture data stored in the picture plane 5, and outputs the result. The overlaid screen shown in FIG. 21 (a screen in which computer graphics rendering an airplane is overlaid in front of a moving image) is generated by means of this adding device, by overlaying the image in the image plane 8, with the picture in the picture plane 5, and outputting the result. In overlaying, the adding device 10 receives an instruction about a mixing rate α, and mixes the pixel values of the images stored in the image plane 5 and the image plane 8 together, according to this mixing rate a. This structure even enables display of an overlaid image in which the pictures rendered by the video data are seen through the computer graphics. Note here that the mixing rate a may be arranged to be modifiable by the dynamic scenario.

The static scenario memory 11 is a memory for storing therein current PL information and current stream management information. The current PL information is one of a plurality of pieces of PL information on a BD-ROM, which is currently a process target. The current stream management information is one of a plurality of pieces of stream management information on a BD-ROM, which is currently a process target.

The playback control engine 12 executes various functions including: AV playback function (1); playlist playback function (2); function of obtaining/setting state of a playback apparatus. The AV playback function of a playback apparatus is a group of functions inherited from the DVD player and the CD player. The AV playback function is specifically for performing, according to a user operation, processing such as “play”, “stop”, “pause on”, “pause off”, “still off”, “forward play(speed)”, “backward play(speed)”, “audio change”, “subtitle change”, and “angle change”. The PL playback function is for performing “play” and “stop”, from the AV playback function, according to PL information. By performing the PL playback function, the playback control engine 12 functions as the third layer in the layer model (i.e. playback control based on a static scenario). The playback control engine 12 performs the AV playback function according to a user operation, and performs the functions (2)-(3) according to a function call from the DVD-like module 16—the browser module 18. That is, the playback control engine 12 performs its function according to an instruction by way of a user operation, an instruction from the higher layers of the layer model, and the like.

The player register 13 is made of 32 system parameter registers and 32 general-purpose registers. The storage values of these registers are used as variables “SPRM” and “GPRM”, for programming. The system parameter registers and the general purpose registers are managed by the playback control engine 12, which is separate from the DVD-like module 16—the browser module 18. Accordingly, even if the playback mode is switched from one to another, the module for performing the playback mode after switching can know the playback state of the playback apparatus, by only referring to the SPRM(0)-(31) and the GPRM(0)-(31) at the playback control engine 12.

The meaning of the setting value (SPRM) of the player status register is shown below. The notation “SPRM(x)” below indicates that this is the setting value of the xth player status register.
SPRM(0): reserved
SPRM(1): stream number of audio stream to be decoded
SPRM(2): stream number of sub-picture stream to be decoded
SPRM(3): number representing angle setting by a user
SPRM(4): number representing title to be currently played back
SPRM(5): number representing chapter to be currently played back
SPRM(6): number representing PL to be currently played back
SPRM(7): number representing CELL to be currently played back
SPRM(8): time information representing current playback time point
SPRM(9): counted value at the navigation timer
SPRM(10): number representing button currently in selected state
SPRM(11)-(12): reserved
SPRM(13): setting of parental level by a user
SPRM(14): setting of playback apparatus relating to image playback
SPRM(15): setting of playback apparatus relating to audio playback
SPRM(16): language code for audio setting in playback apparatus
SPRM(17): language code for subtitles setting in playback apparatus
SPRM(18): language setting for menu rendering
SPRM(19)-(31): reserved

Here, SPRM(10) is updated every time each picture data belonging to the AV stream is displayed. In other words, every time the playback apparatus displays new picture data, SPRM(10) is updated to show the presentation start time (presentation time) of the new picture data. Therefore it is possible to know the current playback time point by referring to this SPRM(10). Likewise, by referring to SPRM(6), it is possible to know the number representing a PL that is a current playback target, and by referring to SPRM(7), it is possible to know the number corresponding to a CELL that is a current playback target.

The memory 14 is a cache memory in which interleave units read from the BD are to be stored. The memory 14 is different from the track buffer 2 in that the memory 14 is not a queue memory on the FIFO (first-in first-out) basis. The other constituting elements can take out data from this memory 14. The memory 14 can delete interleave units according to a request of the other constituting elements.

Every time the optical pickup of the BD drive 1 reads information from the sectors of the BD-ROM, the switcher 15 writes the read information to either the track buffer 2 or the memory 14 by referring to the file management information. In the file management information, the addresses of segments constituting files are stored by being corresponded with file names. Therefore, the read information from the sectors can be stored to either the track buffer 2 or the memory 14, by comparing the sector address of the current read position of the optical pickup with the file management information. If the sector address indicating the current read position falls within a recording area of the file “XXX.M2TS”, then the read information from the BD-ROM is sequentially written to the track buffer 2. If the sector address indicating the current read position falls within a recording area of the library, the read information from the BD-ROM is sequentially written to the memory 14. Although read information from the BD-ROM is in a unit of sector, by repeating writing of read information to the track buffer 2 or to the memory 14, one ACCESS UNIT or one library is eventually obtained on the track buffer 2 or on the memory 14.

The DVD-like module 16 is a DVD virtual player, which is an executing substance of the movie mode. The DVD-like module 16 executes a dynamic scenario in the current movie mode having been read to the dynamic scenario memory 15.

The Java module 17 is a constituting element that corresponds to the Java platform shown in FIG. 13. The Java module 17 executes a dynamic scenario in the current Java mode using the library having been read onto the memory 14.

The browser module 18 is a browser that is an executing substance of the browser mode. The browser module 18 executes a dynamic scenario in the current browser mode having been read onto the dynamic scenario memory 15. Protocols usable by the browser module 18 are HTTP, IP, ARP, RARP, TCP, telnet, SMTP, and ftp, for example.

The UO manager 19 detects a user operation directed to the remote controller or the front panel of the playback apparatus, and outputs information indicating the user operation (hereinafter “UO(user operation)”).

The dynamic scenario memory 21 stores a current dynamic scenario, and provides the current dynamic scenario for processing by the DVD-like module 16—the browser module 18. The current dynamic scenario is one of a plurality of scenarios recorded in the BD-ROM, which is a current execution target.

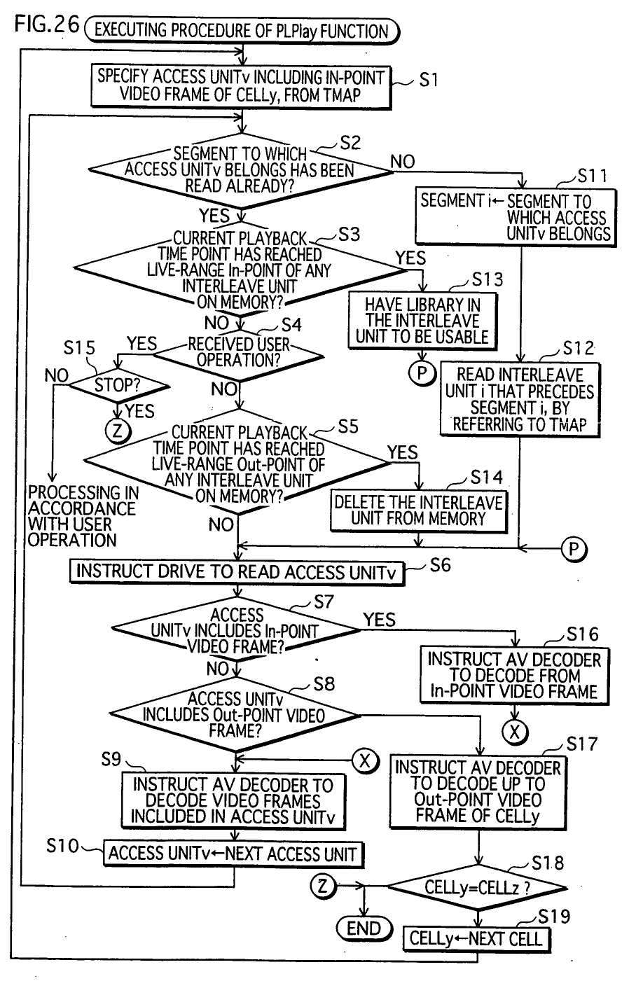

Next, how the playback apparatus of the present embodiment reads interleave units is explained below. Interleave units are read onto the memory 14 together with ACCESS UNITs constituting the AV stream, by the playback control engine 12 when executing PL playback. PL playback is performed in accordance with the process procedure shown in the flowchart of FIG. 26. The playback control engine 12 performs PL playback according to the flowchart of FIG. 26, when calling the PlayPL functions from the DVD-like module 16—the browser module 18. A PlayPL function is a function to be called in notation of “PlayPL(XX,YY)”, and indicates playback of the PL identified by the first argument “XX” from the CELL identified by the second argument “YY”.

Here, assume that the PL to be processed in FIG. 26 is “PLx”, and the CELL to be processed is “CELLy”, and that the ACCESS UNIT to be processed is “ACCESS UNITv”. Prior to this flowchart, the PL identified by the argument of the PLPlay function is set as PLx, and the PLx is read to the memory, thereby identifying the CELL to be processed. If there is no argument specification at function call, the CELLy is set as the first CELL of the PLx, and the CELLz is set as the last CELL of the PLx. The CELLz is a CELL that defines the last of the reading range.

If there is an argument specification, the CELLy is set as the argument-specified CELL, and likewise the CELLz is set as the same argument-specified CELL. The reason why the CELLy and the CELLz are set as the same argument-specified CELL is that then it is only sufficient to read the CELL in the case where argument specification of CELL has been done.

Step S1-Step S19 show the procedure of read/decode the ACCESS UNITs constituting the CELLy. The procedure is as follows. ACCESS UNITv including the In-point video frame of the CELLy is identified from the TMAP (Step S1), then after going through the judgments of Step S2-Step S5, reading of the ACCESS UNITv is instructed to the BD-ROM drive 1 (Step S6). After going through the judgments of Step S7-Step S8, decode of the video frames included in the ACCESS UNITv is instructed to the video decoder 4 (Step S9), then the ACCESS UNITv is set as the next ACCESS UNIT (Step S10).

Step S2 is for judging whether the segment to which the ACCESS UNITv belongs is not read yet. If the ACCESS UNITv is the firstly read ACCESS UNIT in the segment to which the ACCESS UNITv belongs (Step S2: No), then the segment to which the ACCESS UNITv belongs is set as segment i (Step S11), interleave unit i preceding the segment i is read, by referring to the TMAP (Step S12), then reading of the ACCESS UNITv is instructed to the BD drive 1 (Step S6). By doing so, the ACCESS UNITv is read from the BD together with the preceding interleave unit.

Here, the segment including an ACCESS UNIT is stored in the file “XXX.M2TS”, and the library preceding this is stored in the file “ILUsss.CLASS”. Since the segment and the library are respectively stored in two separate files, the playback control engine 12 should perform reading from the file “ILUsss.CLASS” and reading from “XXX.M2TS” successively.

Reading from the file “ILUsss.CLASS” is performed as follows. The file “ILUsss.CLASS” is opened, and the file pointer is set to indicate the beginning position of the opened file “ILUsss.CLASS”. Then a READ command, which is set as the total length of the file “ILUsss.CLASS”, is issued to the BD drive 1. By issuing such a command, the file “ILUsss.CLASS” is read to the memory 14 of the playback apparatus 200.

Reading from the file “XXX.M2TS” is performed as follows. The file “XXX.M2TS” is opened, and the file pointer is set to indicate the beginning position of the ACCESS UNITv in the file “XXX.M2TS”. Then a READ command, which is set as the total length of the ACCESS UNITv, is issued to the BD drive 1. By issuing such a command, the ACCESS UNITv is read to the track buffer 2 of the playback apparatus 200.

Right after the file “ILUsss.CLASS” has been read from the BD drive 1, the file pointer indicates the last position of the file “ILUsss.CLASS” (interleave unit). The segment including the ACCESS UNITv is positioned immediately behind the interleave unit. Therefore a slight move of the optical pickup will enable the file pointer to be set to indicate the beginning position of the ACCESS UNITv.

According to the above structure, in reading from the file “ILUsss.CLASS” and from “XXX.M2TS”, the optical pickup can read the segment and the preceding interleave unit all together, without any seek operations.

Step S3 is for judging whether the current playback time point has reached the IN-point of the live range of any interleave unit in the memory. If the judgment is in the affirmative (Step S3: Yes), then the library in the corresponding interleave unit is made usable (Step S13), and the control is moved to Step S6.

Before the library in the interleave unit is made usable, even when the application program (dynamic scenario in Java mode) instructs the library loading from the memory 14 to the work area of the Java virtual machine, the loading is not performed and it ends up as an exceptional ending, just as when the library has not yet read to the memory 14. On the contrary, after the library in the interleave unit is made usable, the library is transferred to the work area of the Java virtual machine, according to the loading instruction from the application. Such transfer enables the library to be executed by the Java virtual machine.

Step S4 is for judging whether there is any user operation. If the judgment is in the affirmative, whether the operation is a STOP operation is judged (Step S15), and if it is a STOP operation (Step S15: Yes), the processing in this flowchart ends. If the user operation is other than a STOP operation, corresponding processing is performed, and the control will return to the loop processing made of Step S2-Step S10.

Step S5 is for judging whether the current playback time point has reached the OUT-point of the live range of any interleave unit in the memory. If the judgment is in the affirmative, the interleave unit is deleted from the memory (Step S14), and the control is moved to Step S6.

Step S7 is for judging whether the ACCESS UNITv includes an IN-point video frame. If the judgment is in the affirmative (Step S7: Yes), the video decoder is instructed to decode from the IN-point video frame to the last video frame in the ACCESS UNITv (Step S16), and the control is moved to Step S9.

Step S8 is for judging whether the ACCESS UNITv includes the OUT-point video frame of the CELLy. If the judgment is in the affirmative (Step S8: Yes), the video decoder 4 is instructed to decode from the beginning video frame of the ACCESS UNITv to the OUT-point video frame (Step S17), and the judgment of Step S18 is performed. Step S18 is an ending judgment of this flowchart, and is for judging whether the CELLy has become CELLz. If the judgment of Step S18 results in “Yes”, then this flowchart is ended. Otherwise, the CELLy is set as a next CELL (Step S19), and the control returns to Step S1. Hereinafter, until Step S18 results in “Yes”, the processing of Step S1-Step S19 is repeated.

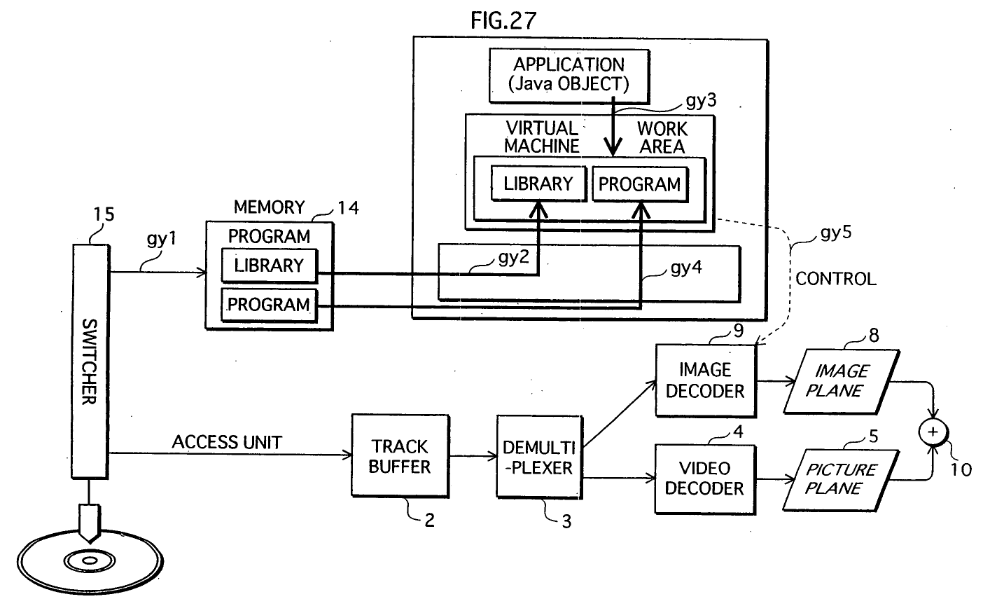

FIG. 27 is a diagram in which, from among the constituting elements of FIG. 25, library-related elements are extracted and drawn. This drawing schematically shows a path by which an application uses or calls a library or a program read to the memory 14 as “ILUsss.CLASS”. The library or the program is recorded in the form of interleave unit ahead of a segment, and so is read to the memory 14 together with the segment (see the arrow “gy1”). The arrow “gy2” indicates a path by which a library is used by an application. The library is loaded from the memory 14 to the work area of the Java module 17. By this loading, the application is able to call the function in the library, as the arrow “gy3” shows.

The arrow “gy4” indicates a path by which the program in “ILUsss. CLASS” is called. The program is loaded from the memory 14 to the work area of the Java module 17. By this loading, the program in “ILUsss.CLASS” is positioned equal to the application, thereby being executable by the Java module 17.

If the library or the application that is loaded to the work area of the Java virtual machine is for performing control “gy5” directed to the image decoder 9, then the image decoder 9 performs decompressing processing and the image after being decompressed is stored in the image plane 8. On the other hand, the ACCESS UNIT has been read to the video decoder 4 via the track buffer 2 and the demultiplexer 3. Therefore the picture plane 5 will obtain non-compressed picture. An overlaid image as shown in FIG. 21 is obtained by overlaying of the image obtained by the image decoder 9 and the picture obtained by the video decoder, which is performed by the adding device 10.

As described above, according to the present embodiment, a library to be executed synchronously with segment playback is arranged ahead of the corresponding segment in the form of interleave unit. Therefore in playing back the segment, the segment and the library to be executed therewith are read together, by an arrangement of deviating the read position of the optical pickup away from the beginning position of the segment. According to this arrangement, it is sufficient that the library that requires synchronous processing is read with the segment, in reading of the segment. Moreover, after the synchronous processing with the segment is ended, the library is deleted from the memory and does not have to be resident during the whole sections of the digital stream playback. In a case where there are a plurality of libraries to be synchronously processed with a digital stream, a playback apparatus will only require a memory of a size sufficient for storing programs required during synchronous processing with a segment playback, under a condition that the library deletion from the memory is performed upon ending of each program. According to such a structure, it is possible to realize synchronous processing between digital stream playback and a variety of libraries, at a minimum memory size.

### Second Embodiment

In the first embodiment, the object to be interleave recorded is a library program; whereas in the second embodiment, the object to be interleave recorded is display data. The display data includes image data, document data, and drawing data. The image data includes JPEG, GIF, PNG, MNG data, which is data displayable by decompression processing performed directly by the image decoder 9. The document data includes HTML/SMIL, XML documents, and text documents, which are data interpreted by the browser module 18, and are made displayable by display control that is based on the interpretation result and is received by the image decoder 9.

The drawing data is data directed to so-called drawing editors, and is data representing three-D shapes and graphic forms by coordinates, vectors, and curvatures. The drawing data is data interpreted by the Java module 17, and is made displayable by control that is based on the interpretation result and is received by the image decoder 9.

Display data, being an interleave unit, is displayed by being synchronized with segment playback. The synchronous display here includes a case where during the segment playback JPEG, GIF, PNG, MNG data is displayed by being overlaid, and a case where during segment playback, HTML/SMIL document, XML document, or text document is displayed in a separate window. A HTML/SMIL document, an XML document, and a text document are used by an application program of browser mode; and JPEG, GIF, PNG, MNG data is used by an application program of Java mode. When a particular scene appears during playback of an AV stream, an application program of Java mode is likely to issue a loading instruction from the cache memory to the work area of the Java virtual machine. Therefore it is necessary to read the display data to the cache memory prior to a period during which synchronous display is planned. Likewise, an application program of browser mode is likely to ask for use of display data. Therefore it is necessary to read the display data to the cache memory prior to a period during which synchronous display is planned. In view of this, in the second embodiment, a live range is calculated from the period during which corresponding display data should be synchronized, so that an interleave unit, which contains the display data, is interleave recorded at a position corresponding to the IN-point of the live range. By doing so, the interleave unit will be read to the cache memory of the playback apparatus immediately ahead of the period during which synchronous display is planned.

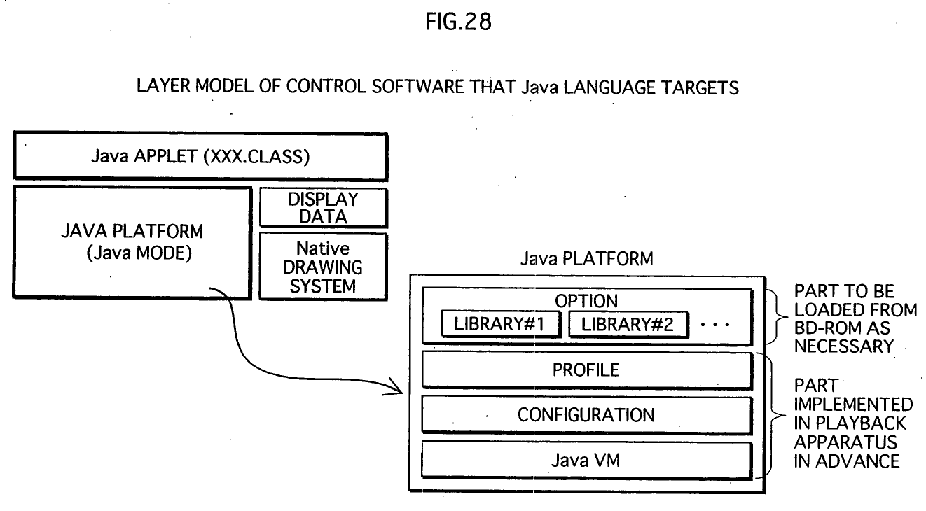

FIG. 28 is a diagram showing where the data is positioned in the layer model that the Java language targets. As this drawing shows, the data to be synchronously displayed with segment playback is positioned in the higher-order layer of the native drawing system.

The display data is interleave recorded to the BD-ROM, just as the case of libraries.

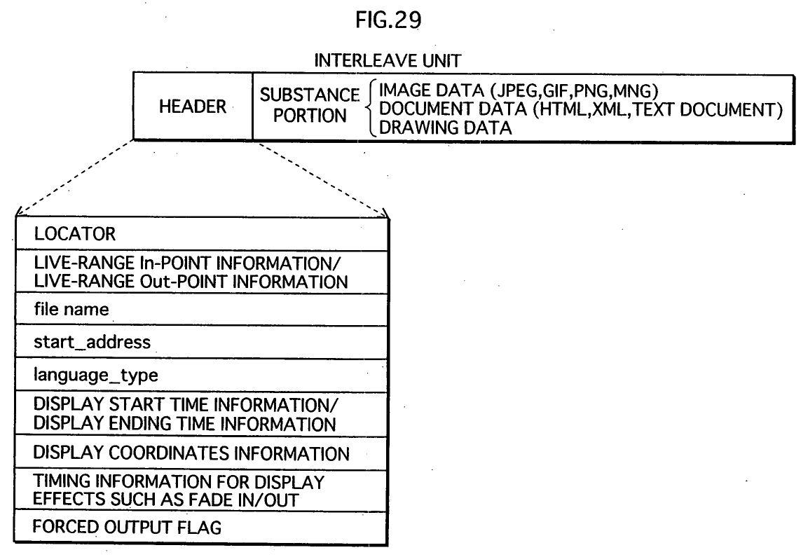

FIG. 29 is a diagram showing a structure of an interleave unit storing therein display data. In this drawing, the header, besides including a locator, live-range IN-point information, and live-range OUT-point information, just as in the first embodiment, includes “file name”, “start_address”, and “language attribute (language_type)” for a file, and “display start time information” “display ending time information” of a file on the playback time axis of the AV stream, “display coordinates information” of a screen, “effect information” for producing a display effect, and “forced output flag”.

The reason why the header includes “display start time information” and “display ending time information” is that the display timing for display data is required to realize synchronous display of the display data included in the interleave unit synchronized with playback of the video data constituting the AV stream. The reason why “display start time information” and “display ending time information” are defined separately from “live range” is to deal with such cases as: a case where display of an interleave unit is not desired, even though the interleave unit has been read to the memory; and a case for repeating display/non-display of display data included in the interleave unit placed on the memory.

The reason why “language attribute (language_type)” is included in the header is that when display data relates to texts or conversations, it is necessary to explicitly show the language used therein.

The reason why “display coordinates” is included in the header is to move display data to a position easy to look at, in a case where the display data is hard to read when overlaying with video data is assumed, depending on the pattern of the video data being a background.

“Effect information” provided in the header is to satisfy the demand for producing effect such as fade-in/fade-out, at the display start or display end of display data.

“Forced output flag” provided in the header is to satisfy the demand for forcing the display even when a user has selected not to display subtitles. In the present embodiment, the display data is recorded in front of a segment, in the form of an interleave unit and with the header as shown in FIG. 29. Next, the improvement on the playback apparatus relating to the present embodiment is explained (i.e. image decoder 9, switcher 15).

The switcher 15, every time the optical pickup of the BD drive 1 reads information from a sector sequence in which interleave units are stored, writes the read information to the memory 14. By repeating the writing of read information to the memory 14, the interleave units will be obtained on the memory 14.

The image decoder 9 refers to the headers of the interleave units stored in the memory, and when the current playback time point reaches the display start time of display data in any interleave unit, draws the corresponding display data, and writes it to the image plane 8. On the other hand, when the current playback time point reaches the display ending time of display data in any interleave unit, the image decoder 9 deletes display data from the image plane 8.

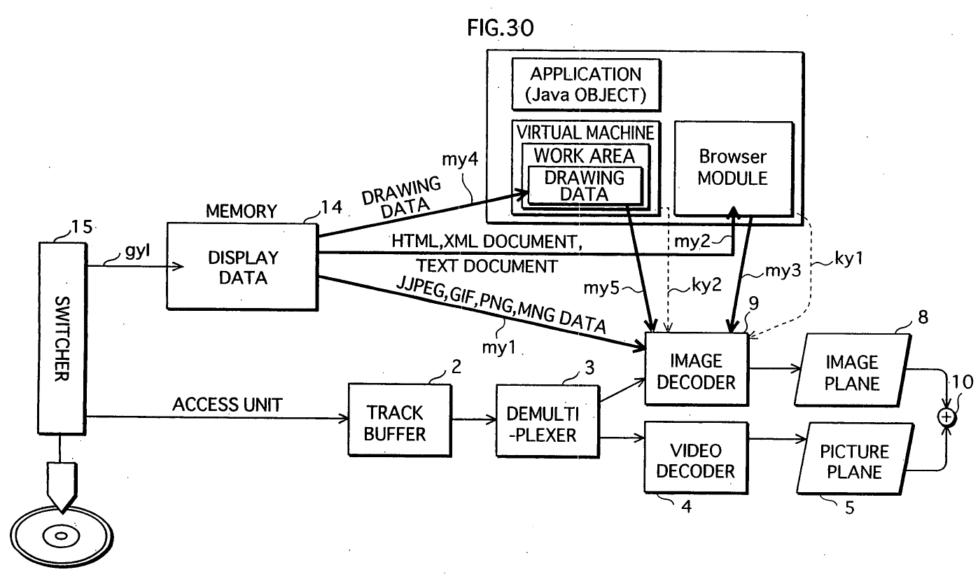

FIG. 30 is a diagram showing the path via which the image data, the document data, and drawing data, each read onto the memory 14 as an interleave unit, are displayed. The arrow “my1” schematically shows the path via which image data is displayed. Image data is read to the memory 14 from the BD-ROM, in the form of interleave unit (gy1), and is directly supplied to the image decoder 9 (my1). The image decoder 9 performs decoding processing, thereby realizing the display.

The arrows “my2” and “my3” are paths via which document data is displayed. Document data is temporarily read to the browser module 18 from the memory 14 (my2). The browser module 18 interprets the document data and outputs the interpretation result (my3). The document data is displayed by display control (ky1) directed to the image decoder 9 performed based on the interpretation result.

The arrows “my4” and “my5” are paths via which the drawing data is displayed. The drawing data is temporarily loaded to the work area of the Java module 17 (my4). The Java module 17 outputs an interpretation result of the drawing data (my5). The drawing data is displayed by display control (ky2) directed to the image decoder 9 performed based on the interpretation result.

As described above, according to the present embodiment, display data is interleave recorded, and so the display data is able to be read to the memory within the playback apparatus synchronously with reading of a segment. Therefore it is possible to easily realize synchronization of segment playback and display data display. By providing information relating to the display data in the header of a corresponding interleave unit, various types of data, being the substance of the interleave unit, are able to be displayed synchronously with playback of the AV stream without changing the format of the display data.

### Third Embodiment

In the first embodiment, synchronous reading of interleave unit and program is realized by placing an interleave unit ahead of the start point of the live range of a corresponding program. However, with the first embodiment, even when a random access is performed to a midway position of a live range, reading should be performed from the beginning of a corresponding interleave unit, and so reading takes long. In a BD-ROM, it is possible to define a playback path by means of playlist information. Therefore it is rare to play back from the beginning of the AV stream in playback-path playback. It is more often that playback starts from a midway position in an AV stream.

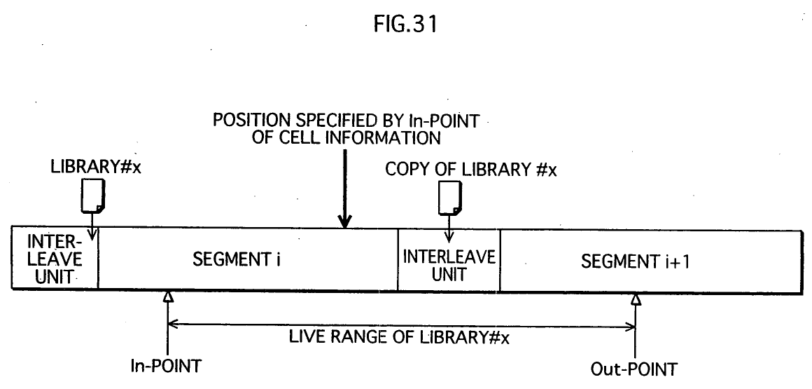

If random access to a midway position of an AV stream or of a segment frequently happens, optimal interleave-unit reading is not possible if with the placement of interleave unit ahead of segment. Therefore the present embodiment proposes redundancy of interleave unit. The redundancy proposed here is to provide a copy of an interleave unit that precedes a particular segment. The place to which the copy should be provided corresponds to a midway position of the live range of a library included in the interleave unit. FIG. 31 is a diagram showing where in a segment a copy of an interleave unit should be incorporated. In this drawing, an AV stream is divided by segment i and segment i+1, at a midway position of the live range of a library #x, and an interleave unit is provided between the segment i and the segment i+1. The interleave unit between the segment i and the segment i+1 includes the library #x, which is a copy of the interleave unit positioned immediately ahead of the segment i. That is, a copy of the interleave unit ahead of the segment i exists at a midway position of the live range of the library #x.

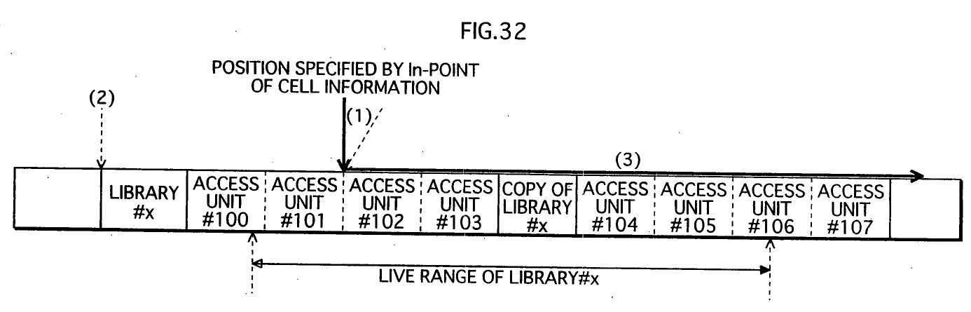

FIG. 32 is a diagram showing how program reading is performed when random access is performed to a midway position of the segment i. (1) in this drawing indicates a random-access point in the segment i.

Since the interleave unit exists ahead of the segment i, it is required, in conventional cases, to perform optical pickup reading ahead of the segment i (which corresponds to the position (2)). However according to the present embodiment, a copy of the interleave unit exists at a midway position of the live range of the program. Accordingly, if reading is performed from the random-access point (1) to (3) as shown in FIG. 32, the copy of interleave unit will be read from the random-access position (1). According to this structure, a copy of an interleave unit is recorded in a midway position of the live range of a library. Therefore when random access is performed to an ACCESS UNIT positioned in midway of the live range, it is possible to start AV stream reading by performing reading from a copy of interleave unit that is in the immediate vicinity. Since it is no more necessary to move the optical pickup to the interleave unit preceding the particular segment, reading from a random-access position of a digital stream and processing with use of a library become easy.

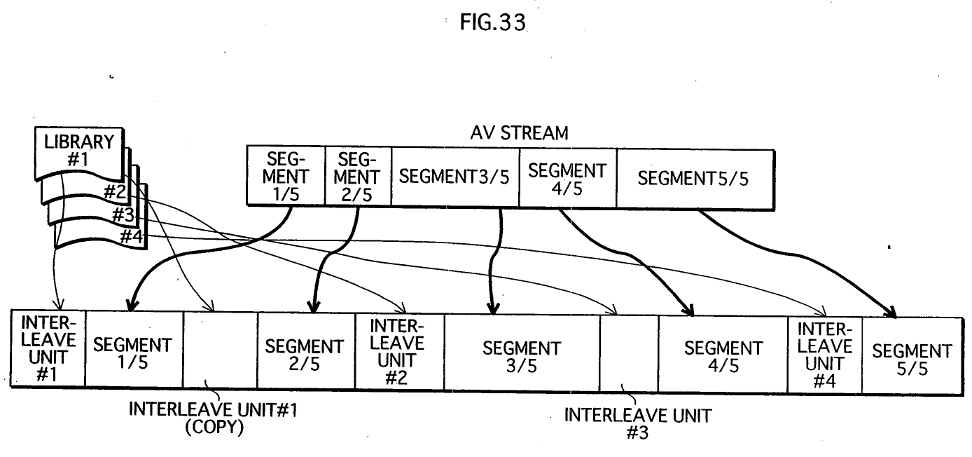

Next, improvement about how to incorporate the four libraries as shown in FIGS. 22-24 into one AV stream is explained. FIG. 33 is a diagram showing a relation between the four libraries #1, #2, #3, and #4 (of FIGS. 22A and 22B) and the segments. Among the segment 1/5—the segment 5/5, the boundaries from the segment 2/5 to the segment 5/5 respectively correspond to In-points of the live ranges for the libraries #1, #2, #3, and #4. However, the boundary between the segments 1/5 and 2/5 exists in a midway point of the live range of the library #1. A copy of the interleave unit #1 is placed in front of the segment 2/5. Thereafter, interleave unit #2, interleave unit #3, interleave unit #4 are respectively placed in front of the segment 3/5, the segment 4/5, and the segment 5/5. Since the copy of interleave unit #1 is placed in front of the segment 2/5, when random access to an ACCESS UNIT included in the segment 2/5, only the scan by means of optical pickup to the copy of interleave unit #1 will enable reading of the interleave unit #1 onto the memory, without moving the optical pickup up to the interleave unit #1 preceding the segment 1/5.

As described above, according to the present embodiment, it becomes possible to place a copy of interleave unit behind the position such as IN-point of a cell, which is among ACCESS UNITs constituting an AV stream and is expected to receive random access often. If this arrangement is made, an application program is able to use a library without performing disc seek up to a corresponding interleave unit placed in front of a segment. Even when random access is expected frequently due to use of PL information in playback, there will be minimum amount of disc seek, and so smooth reading is facilitated.

### Fourth Embodiment

Interleave units are placed in front of program live ranges in the first embodiment and the second embodiment, and the second embodiment also has a copy of interleave unit placed in a midway point of a program live range. However, when a digital stream is played back in the reverse direction, a playback apparatus of any of the described embodiments cannot perform favorable interleave-unit reading. This is because the reverse playback is to go back on the playback time axis of an AV stream in the direction from the future to the past. So as to perform the reverse playback smoothly, the present embodiment provides redundancy for the interleave units. The redundancy here is to incorporate a copy of interleave unit preceding a particular segment, behind the segment.

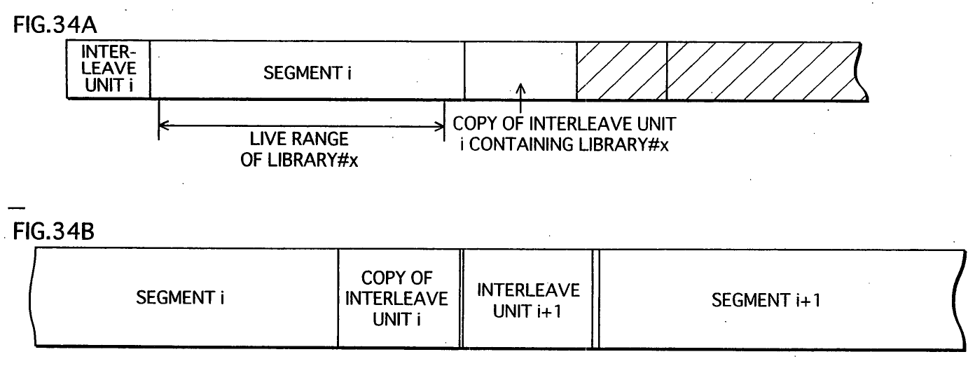

FIG. 34A is a diagram showing the placement of interleave unit, segment, and copy of interleave unit. In FIGS. 34A and 34B, in front of the segment i to be played back in the ith place, the interleave unit i, whose the live range falls during this playback time duration, is placed. The segment i includes IN-point of the live range of the library #x. The interleave unit i includes the library #x. Furthermore, behind the segment i, a copy of interleave unit, which has been placed in front of the segment i, is placed.

FIG. 34B is a diagram to which the i+1th segment is added to FIG. 34A. Just as in FIG. 34A, a copy of interleave unit i is placed behind the segment i, and interleave unit i+1 is placed further behind. Technical meaning of providing such a copy of interleave unit is to efficiently perform reverse playback.

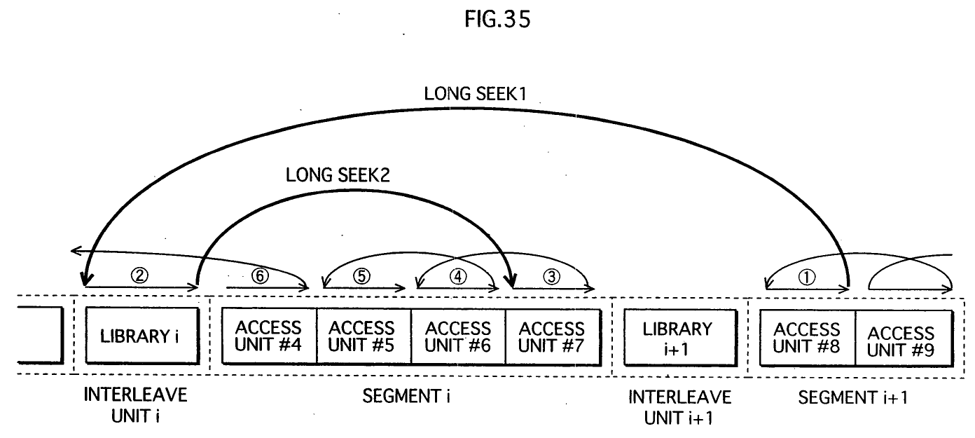

The following compares a case where there is a copy of interleave unit and a case without such a copy. FIG. 35 is a diagram showing how reverse playback is performed when there is a copy of interleave unit. In reverse playback, ACCESS UNITS included in each segment should be read from the last. The arrows (1)(2)(3)(4) in FIG. 35 indicate disc seeks when the segment i+1 includes ACCESS UNIT #8, and the segment i includes ACCESS UNITs #4-#7. The first arrow (1) indicates a disc seek for reading the picture data belonging to ACCESS UNIT#8 included in the segment i+1 from the beginning. The arrow (2) indicates a disc seek for reading the interleave unit i, and the arrow (3) indicates a disc seek for reading ACCESS UNIT #7. The long seek 1 in the drawing indicates a long seek operation after reading ACCESS UNIT#8 in the i+1th segment and before accessing interleave unit i immediately ahead of the ith segment. The long seek 2 indicates a long seek operation after reading interleave unit i and before reading ACCESS UNIT#7.

After the entire i+1th segment is read out, the following two jumps have to be performed: a jump to the interleave unit i (long seek 1); and a jump from the interleave unit i to the last ACCESS UNIT of the ith segment (long seek 2). This seek operation has a lot of waste.

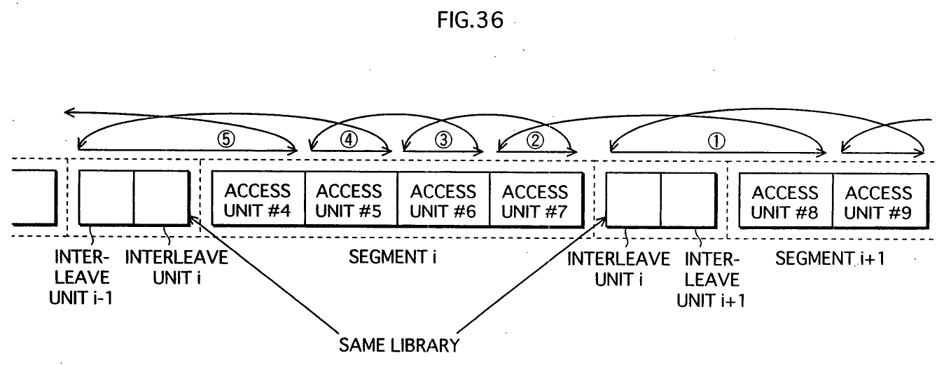

FIG. 36 is a diagram showing seek operations for a BD-ROM in which a copy of interleave unit is incorporated. The difference between this drawing and FIG. 35 is that interleave unit i+1 is placed in front of the i+1th segment, and that a copy of the interleave unit i is placed in front of the interleave unit i+1. Seek (1) is a disc seek for reading a copy of interleave unit i, the interleave unit i+1, and ACCESS UNITs in the i+1th segment. Seek (2) is a disc seek for reading ACCESS UNIT#7 in the ith segment. Seek (3) is a disc seek for reading ACCESS UNIT#6 in the ith segment.

Since the copy of interleave unit i is placed immediately ahead of the interleave unit i+1, in reverse playback, seek (1) enables the interleave unit i to be read together with the first ACCESS UNIT in the i+1th segment. Since interleave units are read simultaneously with reading of segments, the example of FIG. 36 does not necessitate any long seek, and an instant reading of interleave unit i relating to segment i is enabled. By placing a copy of each interleave unit behind a corresponding segment in the above way, occurrence of long seek in reverse playback can be avoided.

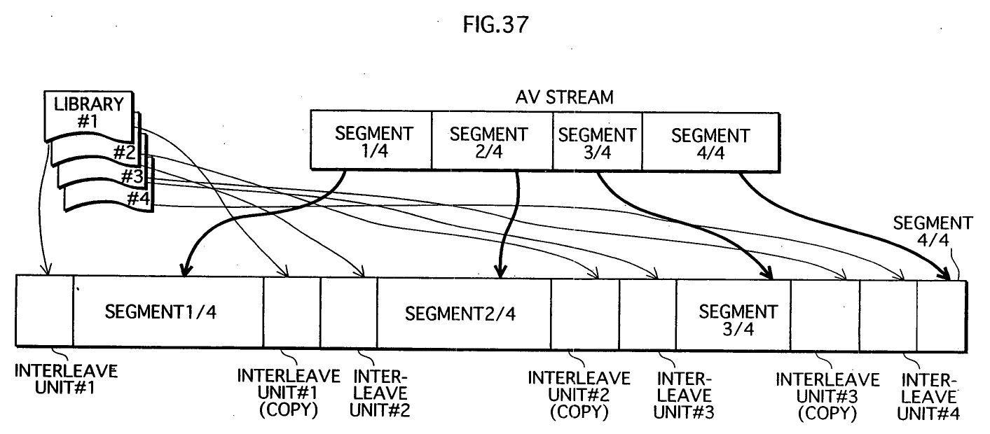

Next, improvement directed to a case where four libraries as shown by FIGS. 22-24 are incorporated into one AV stream is explained. FIG. 37 is a diagram showing a relation between the four libraries #1, #2, #3, and #4 shown in FIG. 22 and the segments. In this embodiment, after the segment 1/4 and before the interleave unit #2, a copy of interleave unit #1 is recorded. In addition, after the segment 2/4 and before the interleave unit #3, a copy of interleave unit #2 is recorded; and after the segment 3/4 and before the interleave unit #4, a copy of the interleave unit #3 is recorded. Such placement of copies prevents occurrence of a long seek in reverse playback.

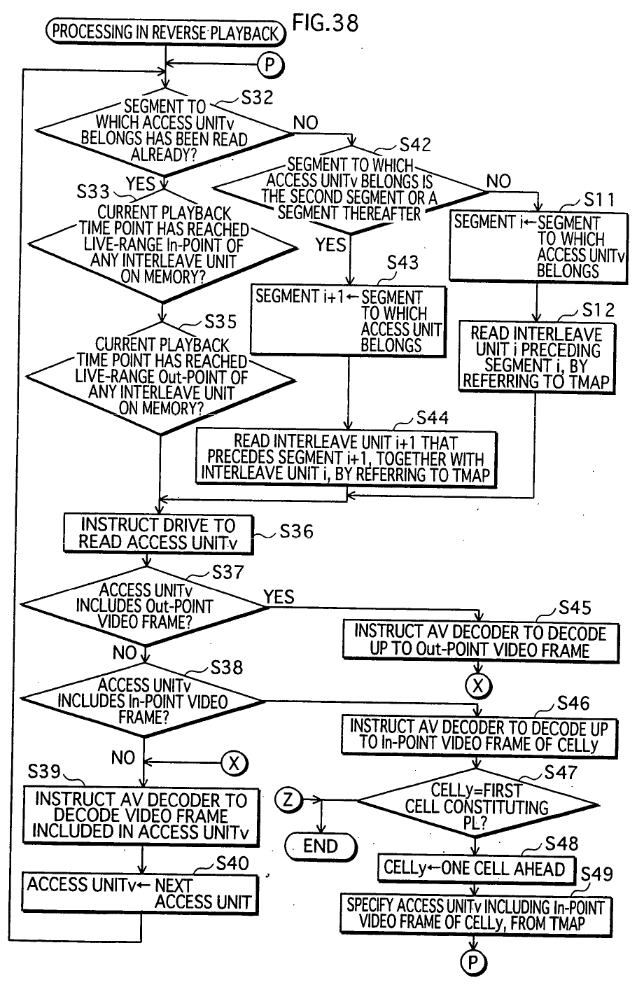

Next, improvement directed to a playback apparatus according to the present embodiment is explained. Disc access shown in FIG. 36 is realized by the processing based on the flowchart of FIG. 38, which is performed by the playback control engine 12 in reverse playback. The flowchart of FIG. 38 is to be performed when a user instructs a reverse playback operation in the flowchart of FIG. 26.

Step S32-Step S40 indicates reading and decoding of ACCESS UNITs constituting CELLy, whose details are as follows. First, judgments of Step S32-Step S35 are performed. Then reading of ACCESS UNITv is instructed to the BD-ROM drive 1 (Step S36). After judgments of Step S37-Step S38 are performed, the video decoder 4 is instructed to decode video frames included in the ACCESS UNITv (Step S39), and the ACCESS UNITv is set as a next ACCESS UNIT (Step S40).

Step S32 is for judging whether the segment to which the ACCESS UNITv belongs has not been read yet. If it has not been read yet, it is judged whether the segment to which the ACCESS UNITv belongs is the second segment or a segment thereafter (Step S42). If the judgment of Step S42 is in the affirmative (Step S42:Yes), then the segment to which the ACCESS UNITv belongs is set as segment i+1 (Step S43), and interleave unit i+1 and interleave unit i, preceding the segment i+1, are read by referring to the TMAP (Step S44). If the segment to which the ACCESS UNITv belongs is the first segment (Step S42:No), then the segment to which the ACCESS UNITv belongs is set as segment i (Step S11), and interleave unit i, preceding segment i, is read by referring to the TMAP (Step S12). Here, the ACCESS UNITv and the preceding two interleave units have been stored in three separate files. Therefore application in Java mode is required to successively issue commands for reading two files corresponding to the two interleave units, and a command for reading “XXX.M2TS”. By moving the optical pickup to the beginning address of a copy of interleave unit, one reading operation of the optical pickup can read a segment and two interleave units preceding to the segment, at once.

Step S33 is the same processing as in Step S3 of FIG. 26, and is for judging whether the current playback time point has reached the IN-point of the live range of any interleave unit on the memory. If the judgment is in the affirmative, the library in the interleave unit is set to be available.

Step S35 is the same processing as in Step S5 of FIG. 26, and is for judging whether the current playback time point has reached the OUT-point of the live range of any interleave unit on the memory. If the judgment is in the affirmative, the interleave unit is deleted from the memory.

Step S37 is for judging whether ACCESS UNITv includes the OUT-point video frame. If the judgment is in the affirmative (Step S37:Yes), the video decoder 4 is instructed to decode from the first video frame in ACCESS UNITv to the OUT-point video frame (Step S45), then the control is moved to Step S39.

Step S38 is for judging whether ACCESS UNITv includes IN-point video frame. If the judgment is in the affirmative (Step S38:Yes), the video decoder 4 is instructed to decode from the IN-point video frame to the last video frame of ACCESS UNITv (Step S46), and then judgment of Step S47 is performed. Step S47 is an ending judgment of this flowchart; specifically, it judges whether CELLy has become the first CELL constituting a PL. If Step S47 has resulted in Yes, the flowchart is ended. Otherwise, CELLy is set as one CELL ahead constituting the PL (Step S48) Then ACCESS UNIT that includes IN-point video frame of CELL is specified from the TMAP, and the control is moved back to Step S32. Thereafter, processing of Step S32-Step S49 will be repeated until judgment of Step S47 results in Yes.

As described above, according to the present embodiment, even when the playback time axis is traced back from the future to the past, for arriving at the live range of a library, reading of the library from a BD-ROM to a memory is realized without performing unnecessary seek. Therefore even when playback progression is irregular such as reverse playback, a library is read to a memory. Therefore, it is possible to realize various types of processing on a premise of AV playback synchronization, even in reverse playback.

### Fifth Embodiment

The fifth embodiment plays back a PL, and performs various types of playback control in synchronization with this playback. The following describes application in Java mode.

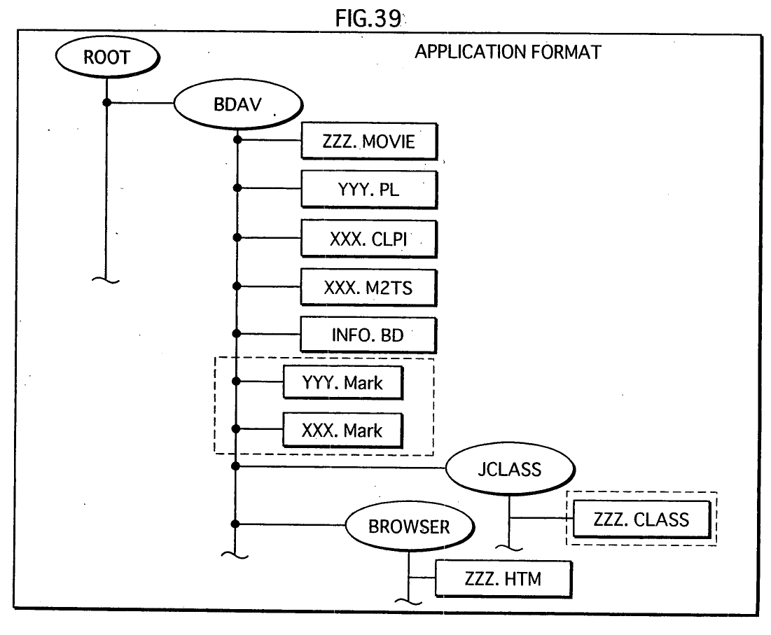

FIG. 39 is a diagram showing the file structure of a BD-ROM according to the present embodiment. What is new in this drawing is that YYY.Mark(PLMark) and XXX.Mark(ClipMark) are added.

PLmark is information showing a section to which a playback apparatus should perform extended control during playback of a PL. The file body “YYY” of the file name “YYY.Mark” is the same as the file body of the file name of PL corresponding to PLMark. Since the file body of the file name of PLMark in this drawing is “YYY”, it corresponds to PL(YYY.PL).

ClipMark is information showing a section to which a playback apparatus should perform extended control during playback of an AV stream. The file body “XXX” of the file name “XXX.Mark” is the same as the file body of the file name of the AV stream corresponding to ClipMark. Since the file body of the file name of Clipmark in this drawing is “XXX”, it corresponds to an AV stream (XXX.M2TS).

The difference between ClipMark and PLMark is as follows. ClipMark specifies a section to which extended control should be performed, in relation to an AV stream, whereas PLMark specifies a section to which extended control should be performed in relation to a PL.

For example, suppose a case where two sets of PL information are defined for one AV stream, as shown in FIG. 11. In this case, if a section to which extended control should be performed is specified using ClipMark, the specification will apply to both of the two sets of PL information specifying this AV stream. On the other hand, if the section to which extended control should be performed is specified using PLMark, the specification will only apply to the PL that corresponds to the PLMark. In other words, if the PL corresponding to the PLMark is PL#1, the specification only applies to PL#1 and not to PL#2. In summary, if a section to which extended control should be performed is specified using ClipMark, the ClipMark will be effective on any PL that includes a particular AV stream. If, on the contrary, such a section is specified using PLMark, the PLMark will be only effective on the PL corresponding to the PLMark.

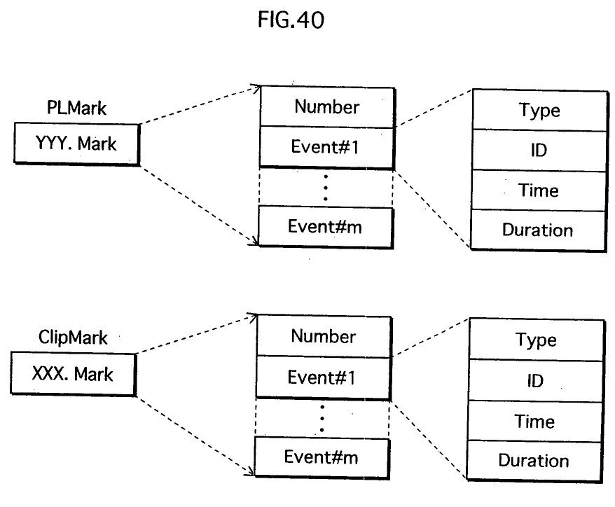

The extended control meant in the present embodiment is to generate an event in the playback apparatus. So as to generate an event, PLMark and ClipMark have a common data structure shown in FIG. 40. FIG. 40 is a diagram showing the common structure shared by PLMark and ClipMark. As this drawing shows, PLMark is composed of event number (number) and each event (event#1-event#m), and defines an event to occur during playback. Each event (Event#) is composed of: type of event (type); ID of event (ID); time at which the event occurs (time); and duration of the period during which the event is effective (duration).

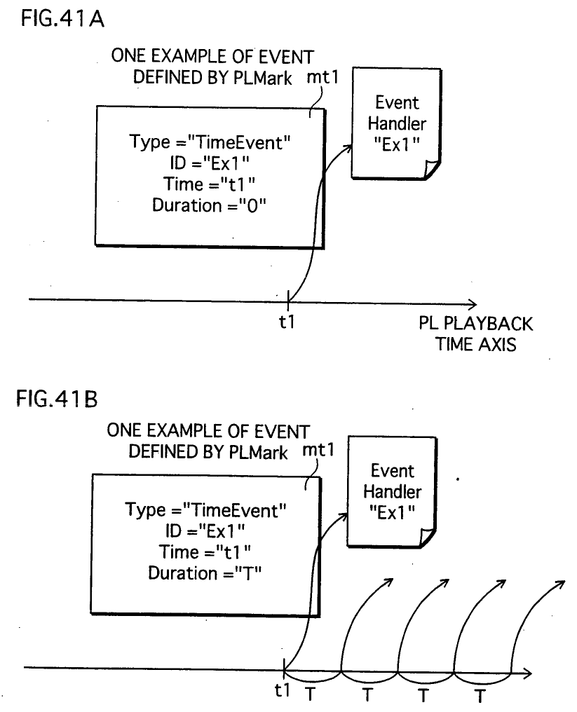

There are two types of event defined by the above data structure: TimeEvent and UserEvent. TimeEvent is an event that occurs when the current playback position reaches a predetermined time T on the playback time axis of a playlist. UserEvent is an event that occurs when a user operation is performed while the current playback position falls in a predetermined period. The following explains, with reference to FIG. 41B, how PLMark is described when TimeEvent, which appears during playback of the playlist #1 (PL#1), is defined. The time axis in the lower level of this drawing represents a time axis along which PL#1 is played back. Here, suppose defining TimeEventEx1 that occurs from the time t1 on this time axis. An example of PLMark description in defining TimeEvent is PLMarkmt1 in this drawing. PLMark is described so that “TimeEvent” is described as Type, “Ex1” is described as ID, “t1” is described as Time, and “0” is described in Duration. The arrow in the drawing indicates TimeEvent at the arrival of time t1. Due to the occurrence of this TimeEvent, the event handler in the drawing will be driven.

In contrast to this, FIG. 41B shows a description example of PLMark in generating TimeEvent at intervals of T from the time t1 of the playback time axis. The difference of FIG. 41B from FIG. 41A is that “T” is described in Duration of PLMark. By the description of Duration, TimeEvent will occur at intervals of T from the time t1.

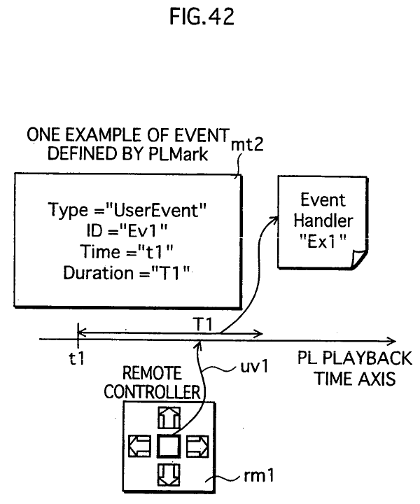

The following explains, with reference to FIG. 42, how to describe PLMark in defining UserEvent during playback of playlist #1. The time axis in the middle level of FIG. 42 is a playback time axis along which PL#1 is played back. A current playback time point on this time axis is shown by SPRM(10). Here suppose a case where UseEvent Ev1 that is to be effective from time t1 for duration T1 is defined. PLMark that defines this UserEvent is PLMark mt2 in this drawing. This PLMark is described such that UserEvent is described in Type, and Ev1 in ID, t1 in Time, and T1 in Duration. The remote controller rm1 in this drawing is an apparatus for receiving a user operation. The arrow “uv1” represents a UO that occurs by a press of ENTER key of the remote controller. If a UO occurs at any time from time t1 for duration T1, UserEvent Ev1 will occur according to the UO. According to this UserEvent, the event handler in the drawing will be driven. Explanation about an event defined by ClipMark is omitted, because event defining by ClipMark is similar to that by PLMark, because the difference between them is simply that ClipMark defines an event to occur during AV-stream playback, whereas PLMark defines an event to occur during PL playback.

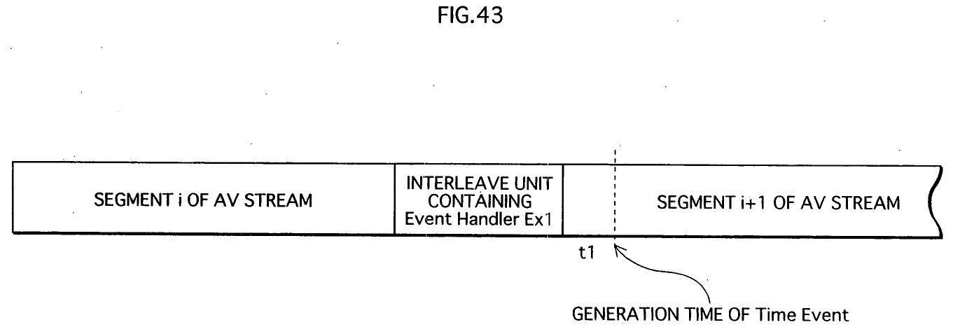

FIG. 43 is a diagram showing a placement example of interleave unit in a case where Clipmark and PL define TimeEvent and UserEvent. In this drawing, the AV stream is divided immediately ahead of time t1 at which TimeEvent is to occur. At the dividing point, an interleave unit storing the event handler Ex1 is recorded.

By being recorded in this way, the interleave unit storing the event handler Ex1 will be read onto a memory together with the segment including time t1. Once an event handler is read to a memory, it becomes possible to load the event handler to the work area of the Java virtual machine, according to a load instruction from an application program. Therefore, when the current playback time point reaches time t1, the event handler Ex1 can be driven instantly.

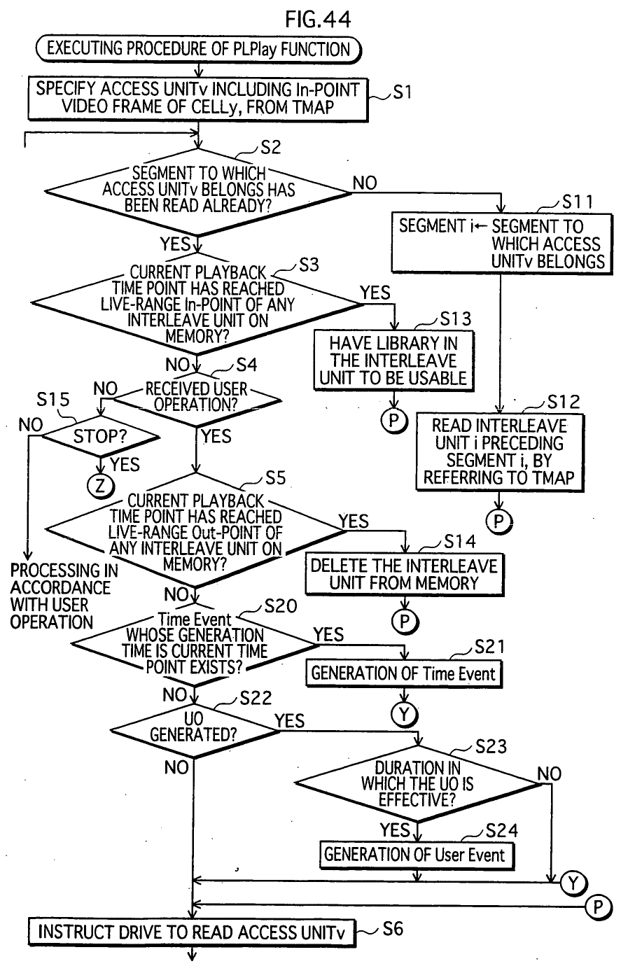

Next, improvement performed on a playback apparatus of the present embodiment is explained. So as to have aforementioned TimeEvent and UserEvent to occur, the playback control engine 12 has to be controlled to perform processing procedure shown in FIG. 44.

FIG. 44 is a diagram showing the processing procedure performed by the playback control engine 12 according to the present embodiment. This flowchart is an improved version of the flowchart of FIG. 22. Accordingly, the same steps are either assigned the same reference signs, or omitted from the drawing. What is new in this drawing is insertion of two judgment steps into a series of processing. Specifically, Step S20 and Step S22 are inserted between step S5 and step S6 of Step S2-Step S10 of FIG. 26. Step S20 is for judging whether TimeEvent, whose generation time is the current playback time point, is defined by PLMark or ClipMark. If Step S20 results in Yes, the TimeEvent is generated (Step S21), and the control is moved to Step S6. An event handler, which has the TimeEvent as a driving requirement, has been recorded in the BD-ROM in the form of interleave unit, and is read to the memory of the playback apparatus together with a corresponding segment. Accordingly, the event handler having the TimeEvent as a driving requirement is instantly driven.

Step S22 is a step for judging whether an UO has occurred. If Step S22 results in Yes, judgment is performed as to whether it is currently in a duration in which the UO is effective, by referring to PLMark and ClipMark (Step S23). If the judgment results in the affirmative, the UserEvent is generated (Step S24), and the control returns to Step S6. An event handler, which has the UserEvent as a driving requirement, has been recorded in the BD-ROM in the form of interleave unit, and is read to the memory of the playback apparatus together with a corresponding segment. Accordingly, the event handler having the UserEvent as a driving requirement is instantly driven.

As described above, according to the present embodiment, an event handler is incorporated between segments in the form of interleave unit, specifically at a position where the event handler driving is planned on the playback time axis of the AV stream. Therefore, when a load instruction for the event handler is issued from the application program, the event handler is ideally loaded to the work area of the Java virtual machine from the memory.

Please note that it is alternatively possible to have the playback control engine 12 to generate an event (pre-event) that occurs prior to PL playback, and an event (post-event) that occurs after PL playback, so as to store an event handler driven thereby to an interleave unit. In this case, it is desirable that the interleave unit store the time that is specified by the first CELL information in the playlist information and the time that is specified by the last CELL information in the playlist information.

In the present embodiment, the explained event handler relates to an event defined by Mark information. However, an event handler to be interleave recorded can also be driven by an event generated by other programs. For example, an event handler to be interleave recorded can be driven by an event generated by an apparatus. Examples of the event generated by an apparatus include an event indicating open/close performed on a BD-ROM, and an event indicating the state of the apparatus (e.g. power failure).

### Sixth Embodiment

In the first and second embodiments, information relating to live range of library and display data is directly described in the header of an interleave unit. Whereas in the sixth embodiment, information relating to live range of library and display data is described in the form of indirect reference.

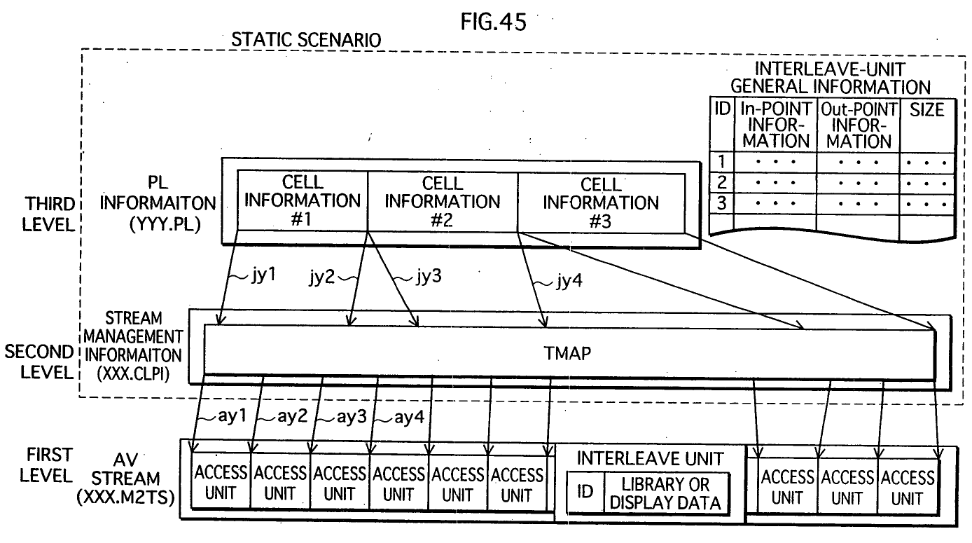

FIG. 45 is a diagram showing how indirect reference is performed to information relating to interleave unit.

In this drawing, the AV stream in the first level is recorded in a BD-ROM by being divided into two segments. Between these segments, an interleave unit is recorded. The interleave unit includes a library and display data. Up to here, the structure is the same as in the first embodiment. However a locator, live-range IN-point information, and live-range OUT-point information, in a header, are replaced by an ID. On the other hand, the static scenario, in the second and third levels, includes interleave-unit general information. This interleave-unit general information describes live-range information for each of interleave units incorporated in the AV stream. In the interleave-unit general information, live-range IN-point information, live-range OUT-point information, and size of interleave unit, are stored in association for each interleave unit. The indirect reference relating to the live-range IN-point information and the live-range OUT-point information is specifically as follows. An ID is described in a header, and the live-range IN-point information and the live-range OUT-point information are made obtainable from the interleave-unit general information using this ID. The described indirect reference does not directly describe an live-range IN-point information or an live-range OUT-point information to a header.

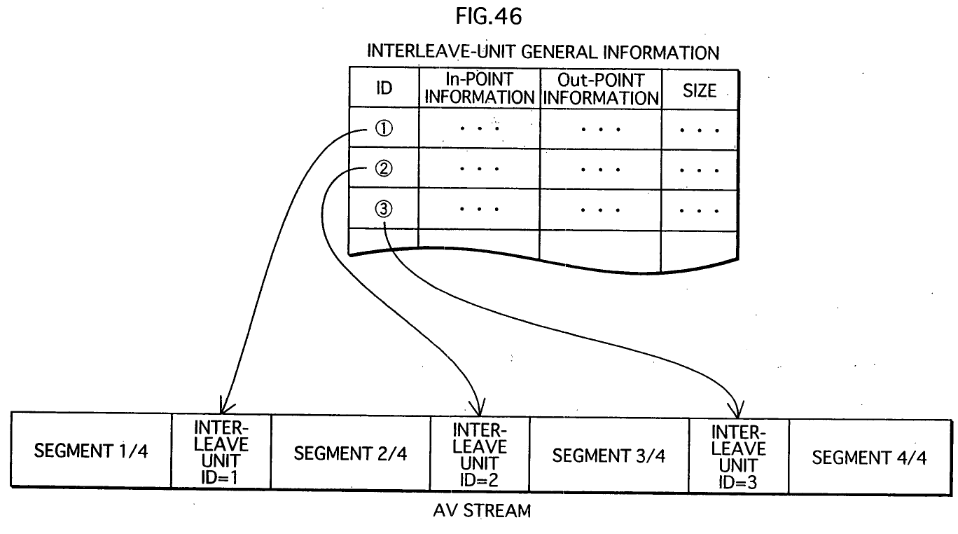

FIG. 46 is a diagram showing the relation between interleave-unit general information and three interleave units incorporated in the AV stream. When the AV stream incorporates therein interleave units respectively assigned ID=1, 2, 3 . . . , the ID=1, 2, 3 are described as the interleave-unit general information, and for each ID, live-range IN-point information, live-range OUT-point information, and size are described. The ID assigned to each interleave unit uniquely identifies whether (1) to which AV stream the interleave unit itself belongs, and (2) the position of the interleave unit in the sequence of the AV stream.

By providing such interleave-unit general information in the static scenario, the playback control engine 12 is able to perform central management of a plurality of interleave units incorporated in an AV stream. An example of the central management is for restricting the number of interleave units to be read to the memory 14, when more than one interleave units have overlapping live ranges with each other.

The interleave-unit general information indicates size and ID, in association, for each interleave unit. Therefore, by accumulating the size of each interleave unit, when a plurality of interleave units are attempted to be simultaneously stored, it is possible to calculate the total size of the interleave units existing on the memory 14. If the calculated size becomes larger than the memory size of the memory 14, an arrangement is possible such that only a part of the interleave units is read onto the memory, without reading all the interleave units whose live ranges are overlapping with each other. Such restriction in the number of reading avoids overwriting of interleave units, as well as avoiding interleave-unit destruction on the memory 14.

As described above, according to the present embodiment, the number of interleave units readable on the cache memory can be estimated prior to actually reading the interleave units. Therefore, capacity lack of the cache memory is avoided in case that there is overlapping of interleave units.

Since how many interleave units are to be read is adjustable according to the memory size of the apparatus, it is no more necessary to show the memory size guideline in numerical forms, such as in a form of “required size for a cache memory”. Since it is no more necessary to show the memory size in numerical forms, discretion in memory size planning is enhanced, which contributes to widespread use of BD-ROM playback apparatuses.

Please note that one piece of interleave-unit general information is provided for each static scenario. However alternatively, it is possible to incorporate it as one information element of the stream management information. In this case, it becomes unnecessary to identify (1) to which AV stream each interleave unit is incorporated. Since it is only necessary to identify the position of a particular interleave unit in the sequence of the AV stream, the bit length of an ID is shortened. Still alternatively, the interleave-unit general information may be incorporated into one information element of PL information.

### Seventh Embodiment

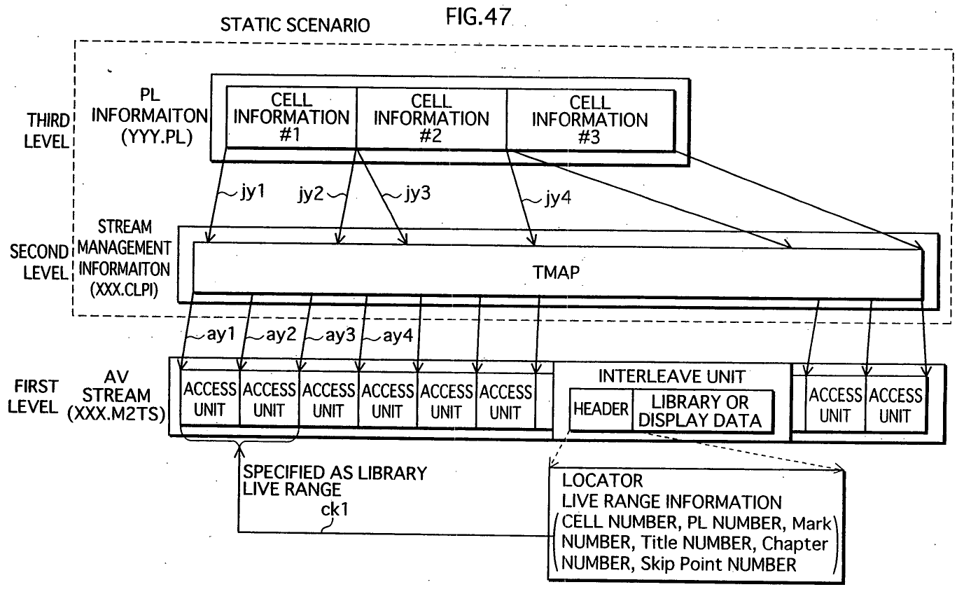

In the first and second embodiments, each live range is represented by IN-point and OUT-point of the live range on the playback time axis, which are indicated by live-range IN-point information and live-range OUT-point information. As opposed to this, the seventh embodiment proposes an indirect notation. The indirect notation proposed in the seventh embodiment is such that each live range is represented by number for CELL information, number for PL information, number for Mark information, number for title, number for chapter, and number for SkipPoint. FIG. 47 is a diagram showing how the live range of each interleave unit in this embodiment is represented.

Here, “CELL information” is assumed to specify one playback section on an AV stream, just as shown in the first embodiment. If the number for CELL information is described in the header of an interleave unit as live range information, “playback section” is able to be defined as “live range” of the interleave unit. In this drawing, if the number for CELL information in the header of an interleave unit indicates CELL information #1, then as shown by ckl, the playback section specified by CELL information#1 (i.e. section specified by ay1-ay2 in the drawing) will be the live range.

“PL information” indicates a playback path composed of one or more playback sections, as shown in the first embodiment. If number for PL information is described in the header of an interleave unit as live range information, a playback path specified by the PL information is able to be defined as the live range of the interleave unit.

“Mark information (ClipMark, PLMark)” specifies a section to which extended control should be performed, as the fifth embodiment describes. By describing number for Mark information in the header of an interleave unit as live range information, a section specified by the Mark information is able to be defined as the live range of the interleave unit.

“Title” corresponds to a movie work comprised of at least a playback path and a dynamic scenario. By describing number for title in the header of an interleave unit as live range information, a live range is also able to be defined from a wide range such as from a movie work.

“Chapter” is a unit that a user recognizes as a chapter of a movie work, and is comprised of one or more pieces of CELL information. By describing number for chapter in the header of an interleave unit as live range information, the live range is able to be defined by a chapter of a movie work, which is a self-explanatory unit for users.

“SkipPoint” indicates a position of a chapter, to which a user has performed marking. Such position is defined by Mark information. By describing number for SkipPoint in the header of an interleave unit, as live-range IN-point information and live-range OUT-point information, the live range is able to be defined by SkipPoint, which is self-explanatory to users.

Next, interleave recording performed for library and display data, in a case where such a live range exists, is explained. The present embodiment is the same as the first embodiment in that a live range exists on an AV stream, even though the live range is represented by a number for CELL information, PL information, Mark information, title, chapter, or SkipPoint. Therefore, a library or display data may be recorded immediately ahead of the position specified by CELL information, PL information—SkipPoint. If the AV stream is divided into a plurality of segments with such a position stated above as a boundary, and that interleave units, each of which includes a library and display data, are recorded between adjacent segments, each interleave unit will be read onto the memory 14 together with a corresponding segment constituting the AV stream, at the start of playback using CELL information, PL information—SkipPoint.

Here, a position specified by CELL information is a position on an AV stream that is specified by IN-point information of the CELL information. A position specified by PL information is a position on an AV stream that is specified by IN-point information of first CELL information within the PL information.

A position specified by a title is a position on an AV stream that is specified by first CELL information within first PL information from among more than one set of PL information constituting the title. Finally, a position specified by Mark information is a position on an AV stream that is specified by time information of the Mark information. A position specified by chapter number and SkipPoint number is respectively a position on an AV stream that is specified by corresponding chapter or SkipPoint.

According to the improvement in the seventh embodiment described above, each live range is represented by number for CELL information, number for PL information, number for Mark information, number for title, number for chapter, and number for SkipPoint. Therefore, the playback control engine 12 of the playback apparatus of the present embodiment performs the following processing.

When playback is instructed using PL information, CELL information, Mark information, title, number for SkipPoint, the playback control engine 12 of the present embodiment specifies an ACCESS UNIT corresponding to a position specified by them, and refers to an ACCESS UNIT entry in the TMAP corresponding to the ACCESS UNIT. If any file name for interleave unit exists in the ACCESS UNIT entry, the ACCESS UNIT having the file name is read successively with the ACCESS UNIT, from the BD-ROM.

Such successive reading is performed at six timings specified below.

The first timing comes when a user performs a selection operation directed to a menu listing titles. If a title selection operation is performed, the playback control engine 12 performs search to see whether the ACCESS UNIT at the position specified by this title has a preceding interleave unit. If a preceding interleave unit is found, the interleave unit is read together with the ACCESS UNIT, to the memory 14 from the BD-ROM. The interleave unit will be kept in the memory 14 until the title playback finishes. After the title playback finishes, the playback control engine 12 deletes the stored interleave unit from the memory 14.

The second timing comes when certain PL information is read to the static scenario memory 11 as current PL information. The playback control engine 12 performs search to see whether the ACCESS UNIT at the position specified by the current PL information has a preceding interleave unit. If a preceding interleave unit is found, the interleave unit is read together with the ACCESS UNIT, to the memory 14 from the BD-ROM. The interleave unit will be kept in the memory 14 until the playback according to the current PL information finishes. When the current playback time point has reached the OUT-point of the last CELL information of the current PL information, the playback control engine 12 deletes the interleave unit from the memory 14. The application program of Java mode, during the aforementioned PL information playback, is enabled to supply the libraries from the memory 14 to the work area of the Java virtual machine, by issuing a load instruction.

The third timing comes when CELL information in current PL information is specified as a playback target (i.e. CELLy in the flowchart of FIG. 26). At this timing, the playback control engine 12 performs search to see whether the ACCESS UNIT at the position specified by the CELL information has a preceding interleave unit. If a preceding interleave unit is found, the interleave unit is read to the memory 14 from the BD-ROM. When the current playback time point has reached the OUT-point of the CELL information, the playback control engine 12 deletes the interleave unit from the memory 14. According to the above-described processing, during the aforementioned CELL information playback, the application program of Java mode is enabled to supply the libraries from the memory 14 to the work area of the Java virtual machine, by issuing a load instruction.

The fourth timing comes when the current playback time point has reached the time indicated by the Mark information. The playback control engine 12 performs search to see whether the ACCESS UNIT at the position specified by the Mark information has a preceding interleave unit. If a preceding interleave unit is found, the interleave unit is read to the memory 14 from the BD-ROM.

The fifth timing comes when a user performs an operation for selecting a chapter from a chapter menu. If a chapter selection operation is performed, the playback control engine 12 performs search to see whether the ACCESS UNIT at the position specified by the chapter has a preceding interleave unit. If a preceding interleave unit is found, the interleave unit is read to the memory 14 from the BD-ROM. Note that when the current playback time point has reached the beginning of a chapter, a search is also performed to see whether the chapter has a preceding interleave unit. If a preceding interleave unit is found, the interleave unit is read to the memory 14 from the BD-ROM.

The sixth timing comes when a user performs an operation for selecting SkipPoint. If a SkipPoint selection operation is performed, the search control engine 12 performs search to see whether the ACCESS UNIT at the position specified by the SkipPoint has a preceding interleave unit. If a preceding interleave unit is found, the interleave unit is read to the memory 14 from the BD-ROM.

As described above, according to the present embodiment, numbers for CELL information and PL information are used to define live ranges. Therefore, it is easy to grasp overlapping between live ranges of interleave units, thereby facilitating planning of interleave-unit reading with a view toward pursuing resource management.

Note that so as to make the search by the playback control engine 12 easier, live range information for interleave units are desirably managed integrally by the interleave-unit general information of the first embodiment. With this structure being realized, it is possible to perform search directed to every interleave unit only by referring to the interleave-unit general information.

In addition, according to the present embodiment, PL information, CELL information, title, chapter, and SkipPoint are corresponded with an interleave unit by means of number. However, any kind of identification information may be used if it uniquely identifies PL information, CELL information, title, chapter, and SkipPoint. For example, identification may be performed by assigning identification information for interleave unit as shown in the sixth embodiment, to PL information or to CELL information.

### Eighth Embodiment

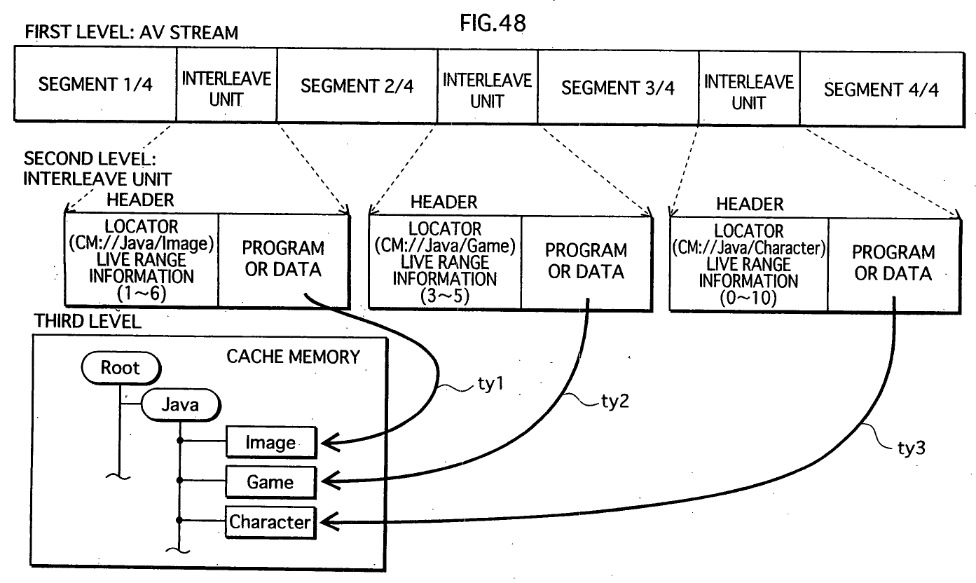

In the first and second embodiments, description of file path in a locator is used to identify each library and program in the memory 14. The eighth embodiment relates to improvement directed to an attempt to organize library and display data on the memory 14 hierarchically, by utilizing such file path description in a header. FIG. 48 schematically illustrates a hierarchical organization of either a program or display data by locator description. The first level of this drawing represents an AV stream, and interleave units which are interleave-recorded in the AV stream. The second level represents the internal structure of each interleave unit and locator description in a corresponding header. The third level represents placement of a program and display data on the memory 14. In the second level, the locators of the interleave units are respectively “CM://Java/Image”, “CM://Java/Game”, and “CM://Java/Character”. Accordingly, when referring to the header of each interleave unit, the playback control engine 12 generates a Java directory on the memory 14, creates files such as “Image”, “Game”, and “Character” in these directories, and places either a program or display data of the interleave units, into each of the files. In this drawing, the arrows “ty1”, “ty2”, and “ty3” schematically show the aforementioned placement. Here, as can be understood by the live range information in the second level, the live ranges of the interleave units are respectively as follows: 1-6 for the interleave unit 1; 3-5 for the interleave unit 2; and 0-10 for the interleave unit 3. The interleave units have overlapping live ranges with each other. According to the above structure, the libraries or display data, which have overlapping live ranges with each other, are respectively stored in files titled “Image”, “Game”, and “Character”, and are placed under one Java directory. Therefore only by accessing the Java directory, an application program of Java mode is able to load library or display data in each interleave units, to the work area of the Java virtual machine.

### Ninth Embodiment

In each embodiment described so far, interleave recording is performed for libraries or display data. As opposed to this, the ninth embodiment relates to improvement so as to incorporate libraries or display data into an AV stream, in the same format as data carousel. Data carousel is a broadcast method by which the same contents is repeatedly broadcast for interactive broadcasting. A BD-ROM, although originally not for storing broadcast data, is made to store libraries and display data by following this data carousel storing format in this embodiment.

Here, transmission in data carousel method is explained. An object of data carousel is divided into a plurality of pieces, and each division becomes a block called “DDB (Download Datablock)”, and is incorporated into an AV stream together with unique control information called “DII (DownloadinfoIndication)”. A DII is placed prior to a corresponding DDB, and has a description of a length of the DDB.

If each of library and display data is considered as an object of data carousel method, then each of library and display data is divided into a plurality of DDBs, with a corresponding header assigned. Then each DDB is placed prior to a position corresponding to IN-point of a corresponding live range. At the timing when a playback apparatus has read the ACCESS UNIT corresponding to the IN-point of the live range, the DDB including either a library or display data is read onto a playback apparatus.

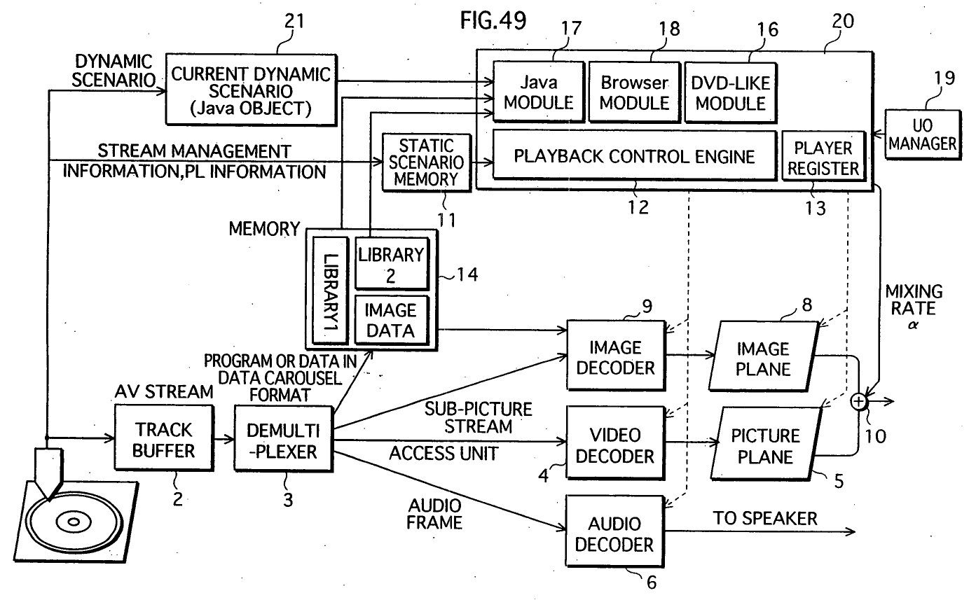

So far, the description relates to improvement directed to an AV stream. The following description relates to improvement of the ninth embodiment directed to a playback apparatus. FIG. 49 is a diagram showing an internal structure of a playback apparatus according to the ninth embodiment.

Since an AV stream includes library and data in data carousel format, a playback apparatus according to the present embodiment does not include a switcher 15 for separating interleave units from the AV stream. Instead, libraries and data are supplied to a memory 14 from the demultiplexer 3. In the playback apparatus of this drawing, the demultiplexer 3 performs multiplexing to an AV stream, so as to obtain a video stream, an audio stream, a sub-picture stream, and library and data in data carousel format. Among them, the library and data in data carousel format are stored in the memory 14, and so the library and data in data carousel format are read to the work area of the Java virtual machine from the memory 14, in response to a load instruction from a Java mode application.

According to the present embodiment, the library and display data usable by an application program of Java mode are supplied to a playback apparatus in the same format as in the data carousel. Therefore, the playback apparatus may have a structure common to that of a reception apparatus for digital broadcast. This realizes a playback apparatus that also functions as a reception apparatus for digital broadcast.

### Tenth Embodiment

The tenth embodiment relates to improvement for omitting a switcher from a playback apparatus, while recording library and display data to a BD-ROM in interleave-recorded form. Since the switcher 15 is omitted, an application program according to the tenth embodiment reads interleave units in the following way.

In reading an interleave unit together with an ACCESS UNIT, the application program performs reading from the file “ILUsss.CLASS” and reading from the file “XXX.M2TS”, successively.

The reading from the file “ILUsss.CLASS” is performed as follows. First, the file “ILUsss.CLASS” is opened, and a file pointer is set to indicate the beginning position of the opened file “ILUsss.CLASS”. Up to here, the procedure is the same as that of the first embodiment. In this procedure, the application program declares an area to which the file “ILUsss. CLASS” is to be read. Then, a READ command to which the total length of the file “ILUsss.CLASS” is set is issued to the BD drive 1. Here, the area to which the file is to be read is the memory 14. As a result of this command issue, the file “ILUsss.CLASS” will be read to the memory 14 of the playback apparatus 200.

The reading from the file “XXX.M2TS” is performed as follows. First, the file “XXX.M2TS” is opened, and a file pointer is set to indicate the beginning position of the ACCESS UNITv in the opened file “XXX.M2TS”. Up to here, the procedure is the same as that of the first embodiment. In this procedure, the application program declares an area to which the file “XXX.M2TS” is to be read. The area to which the file is to be read is the truck buffer 2. Then, a READ command to which the total length of the ACCESS UNITv is set is issued to the BD drive 1. As a result of this command issue, the ACCESS UNITv will be read to the truck buffer 2 of the playback apparatus 200.

As described above, according to the present embodiment, when an application program reads a file, an area to which the file is read is switched depending on the file (i.e. “ILUsss.CLASS” or “XXX.M2TS”). According to this structure, interleave unit reading and AV stream reading are performed without a switcher 15.

### Eleventh Embodiment

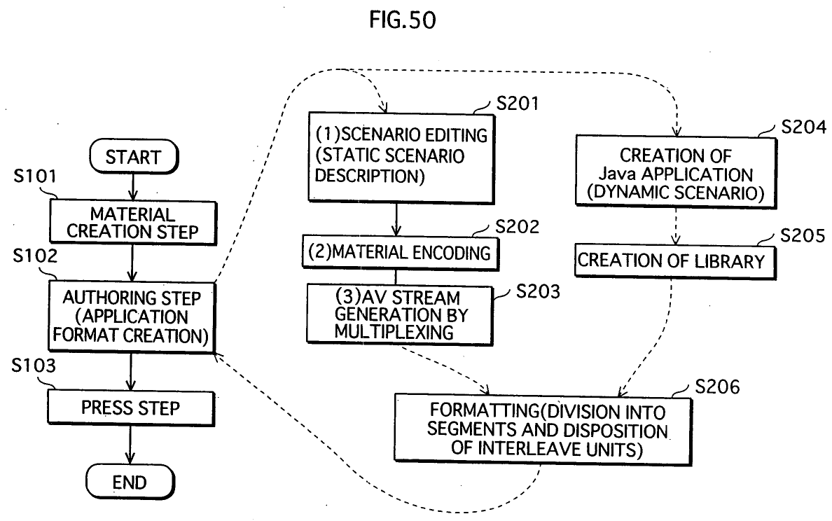

The present embodiment relates to a manufacturing method of a BD-ROM. FIG. 50 is a flowchart showing a manufacturing method of the BD-ROM according to the eleventh embodiment.

The manufacturing method of a BD-ROM includes: material creation step S101 for material creation, such as moving image photographing and sound recording; authoring step S102 for generating an application format with use of an authoring apparatus; and press step S103 for completing a BD-ROM by performing press/bonding.

Among these steps, the authoring step directed to a BD-ROM is comprised of: scenario editing step S201; material encoding step S202; multiplexing step S203; and formatting step S204.

The scenario editing step S201 is a step for converting a scenario created in the planning stage, into a format that a playback apparatus can understand. As a result of the scenario editing, a static scenario for BD-ROM is generated. Also in this scenario editing, multiplexing parameters or the like are generated for multiplexing.

The material encoding step S202 is for encoding a video material, an audio material, and a sub-picture material, respectively, so as to obtain a video stream, an audio stream, and a sub-picture stream.

The multiplexing step S203 is for interleave-multiplexing the video stream, the audio stream, and the sub-picture stream that have been obtained from the material encoding, and converts the streams into one AV stream.

In parallel with these steps, a program in Java language is executed (i.e. Steps S204, S205).

Java-application creation step S204 is for creating a Java application in Java language.

Library creation step S205 is for creating a library.

Formatting step S206 is for having the AV stream, the static scenario, the dynamic scenario, and the library, resulting from Steps S201-S205, to conform to the format of BD-ROM. In the conforming process, the AV stream is divided into a plurality of segments, and libraries are recorded among the segments, as shown in the first embodiment.

In the present embodiment, a dynamic scenario corresponds to a Java application in Step S204 and so is describable in Java language. Therefore the dynamic scenario can be developed in the same way as an ordinary computer software program. Therefore, the present embodiment has an effect of enhancing efficiency in scenario creation.

### Twelfth Embodiment

The present embodiment relates to copying of an AV stream in a BD, to a recording-type recording medium such as BD-R and BD-RE. In copying, a recording apparatus downloads a dynamic scenario and a table from a Web site. Such a table indicates assignment of library live ranges on an AV stream playback time axis as shown in FIG. 22A. Since the table has live-range assignment, the AV stream is divided according to IN-points of live ranges, thereby recording libraries whose live ranges fall within segments, between the segments. Prior to recording, the libraries are converted to interleave units.

By doing so, a BD of a version in which libraries are not recorded can be upgraded to be of a version in which libraries and dynamic scenario are recorded.

(Other Notes)

So far, the present invention has been described based on the embodiments. However the stated embodiments are only system examples that can expect to obtain the best effect at the present state of art. Needless to say, the present invention can be modifiable within the scope of the present invention. Representative modification examples are shown below as (A), (B), (C). . . .

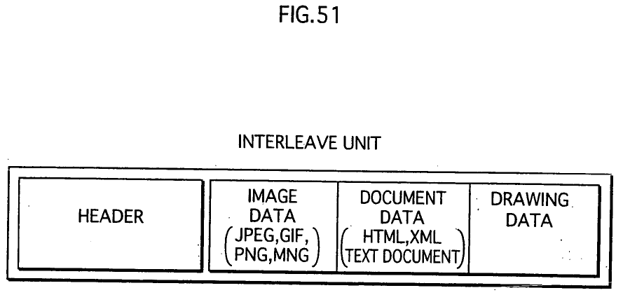

(A) In the second embodiment, only one piece of display data in an interleave unit. However, each interleave unit in a BD-ROM may include a plurality of pieces of display data. FIG. 51 is a diagram showing an interleave unit storing a plurality of pieces of display data. In this drawing, image data, document data, and drawing data are respectively one piece of display data. By recording such interleave units into a BD-ROM, one reading of interleave unit can store a plurality of display data to a memory. Note that in this case, the header is required to have description about respective files included in the interleave unit.

(B) In the layer model shown in FIG. 12, it is possible to, place browser mode or movie mode over the Java mode. In particular, if interpretation of a dynamic scenario and execution of control procedure based on a dynamic scenario are performed in MOVIE mode, the burden for a playback apparatus is light. Therefore, no problem will occur if executing MOVIE mode over the Java mode. In addition, if doing so, operation assurance is possible with one mode in development of a playback apparatus and a movie work.

Alternatively, it is possible to provide only the Java mode so as to execute processing according to the Java mode, without having all the three modes. Playback control synchronized with PL playback is possible only with Java mode, and so provision of MOVIE mode is not compulsory. Furthermore, control on a dynamic scenario may be performed either only with MOVIE mode or only with browser mode.

(C) In all the embodiments, an optical disc was explained as a BD-ROM. However a characteristic of the present invention is interleave units recorded in an optical disc, and this characteristic does not rely on the physical nature of a BD-ROM. Accordingly, any optical disc can be used to realize the present invention. For example, it is possible to use optical discs such as DVD-ROM, DVD-RAM, DVD-RW, DVD-R, DVD+RW, DVD+R, CD-R, CD-RW, and optical magnetic discs such as PD and MO.

Dynamic scenario and playlist information may be recorded in a separate recording medium from a recording medium storing an AV stream and stream management information. The mentioned sorts of data may be read in parallel so as to playback the data as one movie work.

(D) In all the embodiments, the playback apparatus outputs the AV stream of the BD-ROM to a television, after decoding the AV stream. However, the playback apparatus may be comprised of only a BD-ROM drive, and the rest of the constituting elements may be provided for the television. In such a case, the playback apparatus and the television are able to be incorporated into a home network connected through an IEEE 1394 connector. In addition, the playback apparatus in the described embodiments is a type usable by being connected to a television. However, the playback apparatus may be integral-type with a display. Furthermore, in each of the embodiments, only the substance of the processing may be considered as a corresponding playback apparatus. Because all such playback apparatuses are described in the present invention's description, act of producing any of these playback apparatuses based on the internal structure of the playback apparatus of each of the embodiments constitutes an act of practicing the present invention as described in the description. Any act of transfer whether with charge or not (sales if with charge, and gifts if not with charge), rent, and import relating to the playback apparatus of each embodiment also constitute an embodiment of the present invention. In addition, any act of offering these transfer and rent, through storefront display, catalogue solicitation, and pamphlet distribution, also constitutes an act of practicing the present playback apparatus.

(E) Information processing using the programs shown in FIGS. 26, 38, and 44 shown in the flowcharts is actually realized using hardware resources. Accordingly, the programs which describe the operational procedures shown in the flowcharts are themselves an invention. The above embodiments describe the cases where the programs are incorporated in the playback apparatus, but the programs can be used independently of the playback apparatus. Acts of practicing the programs include (1) an act of manufacturing, (2) an act of transfer with or without charge, (3) an act of leasing, (4) an act of importing, (5) an act of providing to the public via a bi-directional electronic communications network, and (6) an act of offering the public for transfer or lease using storefront displays, catalogs, or brochures.

(F) If the time concept existing in each step, which is executed chronologically in the flowcharts in FIGS. 26, 38, and 44, is considered an indispensable factor for specifying the present invention, then each process in the flowchart is interpreted to disclose a use pattern of the playback method. If the processes of the above-explained flowcharts are executed by chronologically executing each step therein, so as to be effective for and instrumental in achieving the object of the present invention, this will correspond to the embodiment of the recording method of the present invention.

(G) The application of Java mode in the embodiments is an application for drawing computer graphics, but is not limited to such. Any application may be used as long as it is described in Java language. For example, a client application in EC (electronic commerce) may be used. It becomes possible to realize Java mode application enabling product presentation with use of moving images from a movie work, for example, which leads to a success in the character business relating to movie works. Furthermore, the application of Java mode may be an online game that will be played on the Internet. Furthermore, characters rendered in computer graphics in the Java mode application may perform processing as an agent. A character, being an agent, may provide help features relating to a playback apparatus, or provide advice to users.

Information that a WebPage object obtains from a WEB site may be a WEB page or image data, or it may further be an AV stream, stream management information, and PL information. In addition, the WebPage object may perform processing in liaison with a search engine.

Furthermore, description language in enhanced mode may alternatively be C++, C#, and the like.

(H) When recording an AV Clip on the BD-ROM, an extension header may be added to each TS packet in the AV Clip. The extension header is called a TP_extra_header, includes an arrival_time_stamp and a copy_permission_indicator, and has a data length of 4 bytes. TS packets with TP_extra_headers (hereafter “EX TS packets”) are grouped in units of 32 packets, and are written to three sectors. One set made up of 32 EX TS packets has 6,144 bytes (=32×192), which is equivalent to a size of three sectors that is 6,144 bytes (=2,048×3). Each of the 32 EX TS packets contained in the three sectors is called an Aligned Unit.

In a home network connected with an IEEE 1394 connector, the playback apparatus 200 transmits an Aligned Unit in the following manner. The playback apparatus removes a TP_extra_header from each of the 32 EX TS packets in the Aligned Unit, encrypts the body of each TS packet according to the DTCP Specification, and outputs the encrypted TS packets. When outputting the TS packets, the playback apparatus inserts isochronous packets between adjacent TS packets. Each point where an isochronous packet is inserted is determined based on a time shown by an arrival_time_stamp of a TP_extra_header. The playback apparatus 200 outputs a DTCP_descriptor, as well as a TS packet. The DTCP_descriptor corresponds to a copy_permission_indicator in the TP_extra_header. With the provision of the DTCP_descriptor indicating “copy prohibited”, it is possible to prevent, when using the TS packet in the home network connected with the IEEE 1394 connector, the TS packet from being recorded to other devices.

(I) In the twelfth embodiment, it is possible to admit copy of an AV stream with restriction by embedding copy generation information (CGI). The copy generation information is classified into: “copy free” indicating copy is possible freely; “one generation copy” indicating that recording of one generation copy is admitted; “no more copy” indicating that further copy of a copy is prohibited; and “never copy” indicating prohibition of any copy. In other words, only when the copy generation information is either “copy free” or “one generation copy”, a backup is performed from an HD to a DVD. If the copy generation information is either “no more copy” or “never copy”, no backup is performed.

(J) When an AV stream is assigned right management information in the twelfth embodiment, a copy of the AV stream may be performed in accordance with a use condition prescribed under the right management information.

If the right management information prescribes copy permit condition by the number of copy, then the number of copy should be observed. If an effective duration is prescribed (year/month/day), then the effective duration should be observed.

(K) When copy processing includes move, migrate, and checkout, or other variations, it is possible to define a backup condition for each variation. The move is copy processing by which deletion of original contents is to be performed. The move is used when contents is moved between a plurality of recording media.

The migrate is copy processing that assumes generation of use condition information on a recording medium to which the copy is to be created.

The checkout is a kind of copy with a restriction in the number of copies. Each copy is performed by decrementing one from the number of permitted copies. The difference between the checkout and the copy with number restrictions is that the checkout can also perform incrementing. Incrementing of the number of copies is performed after processing to prohibit any playback of copied contents on a recording medium (“the processing is called “checkin”).

(L) The AV stream in each embodiment may also be a VOB (video object) in DVD-Video standard or in DVD-Video Recording standard. A VOB is a program stream complying with ISO/IEC13818-1 standard, which is obtained by multiplexing a video stream and an audio stream. In addition, the AV stream in each embodiment may be called “AVClip”. In such a case, the stream management information may be called “Clip information”. In addition, a video stream in an AV stream may be in MPEG4 method or in WMV method. Furthermore, an audio stream may be in Linear-PCM method, Dolby-AC3 method, MP3 method, or in MPEG-AAC method.

(M) Cell information in each embodiment specifies start/ending points of a playback section with use of time information. However, a logical address in a BD-ROM may be used to specify start/ending points of a playback section. A CELL in each embodiment may be called “PlayItem”.

(N) TMAP in stream management information may be called “EP_map”. In this case, a playback start time of an ACCESS UNIT is desirably expressed by a time stamp (presentation time stamp) of the first picture data of the ACCESS UNIT. In addition, an address of each ACCESS UNIT is desirably expressed by a serial number (SPN(serial packet number)) of a PES packet.

(O) In the above explanation about the structure of a playback apparatus, the dynamic scenario memory 21 only stores a current dynamic scenario, and the static scenario memory 11 only stores current stream management information and current PL information. However a plurality of scenarios, pieces of stream management information, and pieces of PL information may be stored in the dynamic scenario memory 21 and in the static scenario memory 11 respectively in advance. By doing so, it is possible to shorten the time lag incident to reading of these pieces of data from a BD-ROM.

(P) So as to sequentially play back two or more CELLs constituting a PL, it is desired that these CELLs are modified for seamless connection in advance.

Modification required for such seamless connection is to create a copy of an ending portion of a preceding playback section and a copy of a starting portion of a succeeding playback section, and then to re-encode thus obtained copies. Note that the copies created for seamless connection may be called “Bridge-Clip”.

Here, the ending portion and the starting portion may be set in the following way.

First, an ending portion is defined as up to the two ACCESS UNITs from the ACCESS UNIT including the Out-point of a preceding playback section within VOB#x. A starting portion is defined as the ACCESS UNIT including the In-point of a succeeding playback section within VOB #x+1. The reason why the ending/starting portions are defined in the above way is detailed in the prior art reference U.S. Pat. No. 6,148,140 of the same applicant. Therefore please refer to the publication document for details.

Furthermore, each copy created for seamless connection is desirably provided with seamless connection information. The seamless connection information includes a playback start time of the first video frame, a playback ending time of the last video frame, a start time of an audio gap, a time length of the audio gap, and position information of the audio gap. If such seamless connection information is defined, it is possible to calculate a difference (STC-Offset) between the time stamps of two sections, using playback start times of first video frames and playback ending times of last video frames, thereby setting the STC-Offset to a playback apparatus. Moreover, it becomes possible to prevent audio interruption incident to transition from one section to another, by referring to these pieces of audio gap information to control the audio decoder.

(Q) A movie work in each embodiment may be any kind of copyright work represented by images, such as a television movie and a game software program. The reason for this is that a movie work in each embodiment has an existing format required of a copyrighted movie, where the requirements are such that (i) being presented on a cathode-ray tube or on a liquid-crystal screen, or the like, using a method by which a visual effect or an audiovisual effect is generated, (ii) existing by maintaining identity by having connection to a BD-ROM (a substance) in a certain method, and (iii) being placed in a state ready to be played back.

However, the essence of the present invention is not limited to such a movie work. The video data of the present invention may alternatively be an image in a monitor camera, or an image photographed by a home video camera.

(R) In the second embodiment, the drawing data may be computer graphics data. Such data includes data in NURBS (non uniform rational B-spline) format, and polygon format. NURBS is a bundle of Bezier curves (the bundle being called “B-Spline”), where curvatures of the Bezier curves are not uniform.

Polygon format is defined to express a particular cubic form by polygon approximation, which includes a representative example of data exchange format (DXF) by AutoCAD Co. (a U.S. company). Other examples are HRC, WAVEFRONT, IV, and VRML formats.

In addition, it is also possible to use image data shown in the second embodiment as texture mapping. Texture mapping is processing for displaying a texture pattern such as still image and bit map, onto three dimensional plane and curved plane. So as to render computer graphics, it is possible to interleave record programs such as OPEN-GL or Java3D.

(S) In each embodiment, a selection operation from a user for a movie work is received via a remote controller. However, the selection operation may alternatively be received via a front panel of a playback apparatus. Still alternatively, the selection operation may be received via an input apparatus such as a keyboard, a touch panel, a mouse or a pad, and a track ball. In these cases, the selection operation may be received by means of a click operation or a drag operation.

(T) A movie work in each embodiment may be obtained by encoding analogue image signals broadcasted through an analogue broadcast. The movie work may alternatively be stream data made up of a transport stream broadcasted through a digital broadcast.

In addition, the movie work may be a content obtained by encoding analogue/digital image signals recorded in video tape. Alternatively, the movie work may be a content obtained by encoding analogue/digital image signals directly taken in from a video camera. Still alternatively, the movie work may be a digital work distributed from a distribution server.

(U) The Java module 17 may be a Java platform incorporated in an apparatus for the purpose of receiving a satellite broadcast. If the Java module 17 is such a Java platform, the playback apparatus of the present invention can further function as STB for MHP.

Alternatively, the Java module 17 may be a Java platform incorporated into an apparatus for the purpose of controlling processing relating to a portable telephone. If the Java module 17 is such a Java platform, the playback apparatus of the present invention can further function as a portable telephone.

In addition, the browser module 18 may be browser software incorporated into a personal computer, such as Internet Explorer by MicroSoft Corporation.

### INDUSTRIAL APPLICABILITY

An optical disc according to the present invention will make an operation environment for game software close to an operation environment for movie playback, and so helps distribute more attractive movie works to the market, which invigorates the movie market and the consumer goods market. Accordingly, the recording medium and the playback apparatus according to the present invention are highly applicable in the movie industry and the consumer goods industry.

1. An optical disc having recorded therein a digital stream divided into n segments, wherein
an interleave unit is recorded in front of an ith segment to be played back in an ith place, where each of i and n is an integer that satisfies i<n, and the interleave unit includes one of (a) a program to be synchronized with playback of the ith segment and (b) data to be displayed synchronously with playback of the ith segment.

2. The optical disc of claim 1, wherein
the interleave unit includes ending time information that indicates at which point on a playback time axis of the digital stream the program or the data should be deleted from a memory.

3. The optical disc of claim 1, wherein
the interleave unit includes start time information that indicates at which point on a playback time axis of the digital stream the program or the data becomes usable.

4. The optical disc of claim 1, wherein
a copy of the interleave unit is recorded between the ith segment and an i+1th segment.

5. The optical disc of claim 4, wherein
a boundary between the ith segment and the i+1th segment falls in a middle of a live range of the program or the data.

6. The optical disc of claim 4, wherein
a boundary between the ith segment and the i+1th segment falls after a live range of the program or the data.

7. The optical disc of claim 1, wherein
the ith segment is made of a plurality of access units, each access unit containing video data having an intra picture, and the optical disc has recorded therein map information that shows the interleave unit in association with one of an address and a playback time of each of the access units belonging to the ith segment.

8. The optical disc of claim 1, wherein
i≧2, and a boundary between the ith segment and an i−1th segment corresponds to a start point of a live range of the program or the data on a playback time axis of the digital stream.

9. The optical disc of claim 8, wherein
the live range is a section on the playback time axis, during which the program or the data becomes usable.

10. The optical disc of claim 1, wherein
the program is an event handler that is driven by an event, and an interleave unit including the event handler is recorded in front of a time at which the event occurs on a playback time axis of the digital stream.

11. The optical disc of claim 10, wherein
the event is one of (a) an event indicating that a current playback time point has reached a predetermined time on a playback time axis, (b) an event indicating that a user operation is made during a predetermined time duration of the playback time axis, (c) an event occurring prior to playback according to a playback path, (d) an event occurring after playback according to a playback path, (e) an event generated by the playback apparatus, and (f) an event generated by another program.

12. The optical disc of claim 1, further having recorded therein interleave-unit general information that shows identifiers of a plurality of interleave units recorded in the optical disc, in association with a size and a live range of a corresponding program or data.

13. The optical disc of claim 1, further having recorded therein playlist information and a dynamic scenario, wherein
the playlist information defines a playback path by disposing pieces of information indicating playback sections of video data according to a playback order, the dynamic scenario defines a video title by showing a playback procedure of at least one playback path, and the interleave unit contains an identifier that shows, as a live range of the program or the data, one of a playback path, a playback section, an entire video title, and a chapter of the video title.

14. The optical disc of claim 1, wherein
the interleave unit contains a locator that contains drive information and path information, the drive information indicating a drive to which the program or the data is to be read, and the path information indicating in which layer of a layer structure of the drive the program or the data exists.

15. A playback apparatus for an optical disc having recorded therein a digital stream, the playback apparatus comprising:
a reading unit operable to read, from the optical disc, an ith segment to be played back in an ith place from among n segments constituting the digital stream, together with an interleave unit preceding the ith segment, where each of i and n is an integer that satisfies i<n;
a playback unit operable to play back the read ith segment; and
a processing unit operable to perform synchronous processing using a program or data included in the read interleave_unit, in synchronization with playback of the ith segment.

16. The playback apparatus of claim 15, comprising:
a memory operable to store the read interleave unit; and
a track buffer operable to store the read ith segment, wherein
the playback unit receives supply of the ith segment via the track buffer, and the processing unit receives supply of the interleave unit via the memory.

17. The playback apparatus of claim 16, further comprising a switcher, wherein
the read unit, upon reading a sector of the optical disc, makes a notification of an address of the sector, the switcher (a) writes information read from the sector to the memory when judging that the notified address from the read unit falls within an area for storing interleave units, and (b) sequentially writes information read from the sector to the track buffer when judging that the notified address from the read unit falls within an area for storing segments, each interleave unit on the memory is made of information that the switcher has written to the memory, and each segment on the track buffer is made of information that the switcher has written to the track buffer.

18. The playback apparatus of claim 17, wherein
in the optical disc, each interleave unit is stored in a file separately from the digital stream, the optical disc has recorded therein file management information that indicates each file identifier in association with an address in the optical disc of one of the digital stream and an interleave unit, and judgment as to whether a current read position is within the area for storing interleave units or within the area for storing segments is performed by referring to the file management information.

19. The playback apparatus of claim 16, wherein
in the optical disc, each interleave unit is stored in a file separately from the digital stream, the optical disc has recorded therein file management information that indicates each file identifier in association with an address in the optical disc of one of the digital stream and an interleave unit, and the read unit, before performing the reading, opens each file for specifying the memory as a reading destination for a file storing an interleave unit, and specifying the track buffer as a reading destination for a file storing the digital stream.

20. The playback apparatus of claim 16, wherein
the interleave unit contains ending time information, and the processing unit deletes the interleave unit from the memory when a current playback time point of the playback unit has reached an ending time that the ending time information indicates.

21. The playback apparatus of claim 16 further comprising a virtual machine subunit, wherein
the processing unit, upon request by an application program, supplies the program or the data in the interleave unit on the memory to a work area of the virtual machine subunit, and has the virtual machine subunit to execute the program or the data.

22. The playback apparatus of claim 21, wherein
the interleave unit contains start time information, and the processing unit supplies the program to the work area of the virtual machine subunit upon request by the application program when the current playback time point of the playback unit has reached a start time that the start time information indicates, and the current playback time point of the playback unit has not reached the start time, the processing unit does not supply the program to the work area of the virtual machine subunit, even upon request by the application program.

23. The playback apparatus of claim 15, wherein
a boundary between the ith segment and an i+1th segment falls in a middle of a live range of the program or the data, a copy of the interleave unit is recorded between the ith segment and the i+1th segment, and the read unit reads the copy from the optical disc when a random access is performed to the ith segment.

24. The playback apparatus of claim 15, wherein
a boundary between the ith segment and an i+1th segment falls after a live range of the program or the data, a copy of the interleave unit is recorded between the ith segment and the i+1th segment, the read unit reads the ith segment when the playback unit performs normal playback, and the playback unit, when performing reverse playback, reads the i+1th segment among the n segments, together with the copy of the interleave unit preceding the i+1th segment.

25. The playback apparatus of claim 15, wherein
the ith segment is made of a plurality of access units, each access unit containing video data having an intra picture, the optical disc has recorded therein map information that shows the interleave unit in association with one of an address and a playback time of each of the access units belonging to the ith segment, and the read unit performs reading of the interleave unit, by referring to the map information.

26. The playback apparatus of claim 15, wherein
the processing unit includes a virtual machine subunit, the playback unit plays back the digital stream and generates an event synchronized with the playback, and the virtual machine subunit, when the playback unit has generated the event, executes the program in the interleave unit.

27. The playback apparatus of claim 26, wherein
the event is one of (a) an event indicating that a current playback time point has reached a predetermined time on a playback time axis of video data, (b) an event generated by the playback apparatus, and (c) an event generated by another program.

28. The playback apparatus of claim 27, wherein
the optical disc has recorded therein mark information that defines a predetermined time point and a predetermined time interval on the playback time axis, and the playback unit generates the event according to the mark information.

29. The playback apparatus of claim 27, comprising a reception unit operable to receive a user operation, wherein
the event is an event that indicates that the reception unit has received a user operation in a predetermined time duration of the playback time axis of the video data.

30. The playback apparatus of claim 15, wherein
the optical disc has recorded therein interleave-unit general information being management information for a plurality of interleave units recorded on the optical disc, the playback apparatus includes a memory and a playback control unit that is operable to judge, according to the interleave-unit general information, whether the interleave units are storable in the memory, and the read unit reads part or all of the interleave units when the playback control unit has judged affirmatively.

31. The playback apparatus of claim 15, wherein
the optical disc has recorded therein playlist information that defines a playback path by disposing pieces of information indicating playback sections of the digital stream according to a playback order, and the playback control unit controls the read unit and the playback unit so as to play back the digital stream according to the playlist information.

32. The playback apparatus of claim 31, wherein
each interleave unit contains an identifier, and the playback control unit, in playing back the digital stream according to the playlist information, controls the read unit to read, from the optical disc, one of (a) an interleave unit containing an identifier of the playlist information and (b) an interleave unit containing an identifier of information that indicates a playback section of the playlist information.

33. The playback apparatus of claim 31, wherein
the optical disc has recorded therein a dynamic scenario, the dynamic scenario defining a title by showing a playback procedure of at least one playback path shown by playlist information, the playback control unit controls the read unit to read, from the optical disc, one of (a) an interleave unit containing an identifier of the title corresponding to the dynamic scenario and (b) an interleave unit containing an identifier of a chapter included in the title corresponding to the dynamic scenario.

34. The playback apparatus of claim 15, wherein
each interleave unit contains a locator that contains drive information and path information, the drive information indicating a drive to which the program or the data is to be read, the path information indicating in which layer of a layer structure of the drive the program or the data is to be disposed, and the playback apparatus disposes the program or the data in the layer indicated by the path information.

35. A playback program for an optical disc having recorded therein a digital stream, the playback program comprising:
a reading step of reading an a ith segment to be played back in an ith place, from among a plurality of segments constituting the digital stream;
a playback step of playing back the read ith segment; and
a processing step of performing synchronous processing using a program or data included in the read interleave unit, in synchronization with playback of the ith segment.

36. A playback method for an optical disc having recorded therein a digital stream, the playback method comprising:
a reading step of reading an a ith segment to be played back in an ith place, from among a plurality of segments constituting the digital stream;
a playback step of playing back the read ith segment; and
a processing step of performing synchronous processing using a program or data included in the read interleave unit, in synchronization with playback of the ith segment.

37. A recording method for an optical disc, the recording method comprising:
a step of creating application data; and
a step of recording the created application data to the optical disc, wherein
the application data contains a digital stream divided into n segments and an interleave unit, the interleave unit is recorded in front of an ith segment to be played back in an ith place, where each of i and n is an integer that satisfies i<n, and the interleave unit includes one of (a) a program to be synchronized with playback of the ith segment and (b) data to be displayed synchronously with playback of the ith segment.
